(19) United States
(12) Patent Application Publication
(10) Pub. No.: US 2003/0195868 A1
(43) Pub. Date: Oct. 16, 2003

(54) Methods and systems for correlating company data stored in an electronic database

(76) Inventors: Eleanor Sothern Wilson, Westport, CT (US); Anne Frederick McDowell, Wilton, CT (US)

Correspondence Address: John S. Beulick, Armstrong Teasdale LLP, Suite 2600, One Metropolitan Square, St. Louis, MO, 63102, US

(21) Appl. No.: 10/060,464

(22) Filed: Jan. 30, 2002

(51) Int. Cl. G06F 7/00

(52) U.S. Cl. 707/3

(57) ABSTRACT

Methods and systems for operating a computer in response to a search request for company data for one company stored in a plurality of databases is provided. In one embodiment, a plurality of company names are linked to a unique identifier for the one company, and the search request identifies a data type and the one company. The method comprises the steps of operating the computer to select at least one of the databases to search based on the identified data type and company, select at least one of the plurality of company names to utilize in the search, and perform the search in the selected databases using the selected company names. The operation of correlating company names and locating the desired data is transparent to the system user.

### BACKGROUND OF THE INVENTION

This invention relates generally to data management, and more specifically, to correlating data from multiple sources.

Scorecards typically are utilized in financial businesses in assessing whether to enter into a particular financial transaction with another company and in assessing a current status of transactions with that company. A typical scorecard includes, for example, ratings information from public sources as well as ratings internally generated by the financial business. The internal ratings are based, for example, on data collected by the financial business from past transactions entered into with the company. In a financial business that enters into thousands of transactions with other companies, however, the data related to one particular company may be spread out across multiple databases and may have been entered into the databases by many different people. Accessing all information relating to the particular company therefore may be extremely difficult. As a result of an inability to easily and quickly access all information within the financial business regarding the particular company, different scorecards for one company may be generated for different deals across the financial business.

In addition, since data is spread out across multiple databases, a financial businesses may not have a single point of entry and access to information regarding a particular company. For example, with data about a particular company being provided by multiple sources and accessible in many different databases, there exists a strong likelihood that many different identifiers will be employed by the various sources and in the different databases to identify the particular company. A company such as General Electric Company may be referenced using different identifiers such as General Electric Company, GE, GE Company, and GE Co. As a result of using many different identifiers for any one company, simply associating the comprehensive data with the one company can be extremely difficult and time consuming.

### BRIEF SUMMARY OF THE INVENTION

In one aspect, a method for operating a computer in response to a search request for company data for one company stored in a plurality of databases is provided. A plurality of company names are linked to a unique identifier for the one company, and the search request identifies a data type and the one company. The method comprises the steps of operating the computer to select at least one of the databases to search based on the identified data type and company, select at least one of the plurality of company names which is linked, or correlated, by a unique identifier to all relevant “aliases” (i.e., other names used in the database to refer to the company) for the same company name to utilize in the search, and perform the search in the selected databases using the selected company names.

In another aspect, a company database system comprising a plurality of databases is provided. At least one processor is coupled to the databases, and a memory is coupled to the processor. The memory has a plurality of unique company identifiers stored therein. Each unique company identifier is linked to at least one company name. That is, each unique company is assigned a unique company identifier which may be correlated with a plurality of names for that unique company.

In yet another aspect, a method for alerting a user of a change in status of a company is provided. More specifically, via a user computer, a user inputs (e.g., to the system processor) instructions identifying a company and a type of change relating to the company which the user desires to receive notification. As data is supplied to the system, the data is stored in the database. The system/server processor periodically (e.g., daily) selects at least one databases to search based on the specified type of change and the company. The processor also selects at least one of company names linked to the unique identifier to utilize in the search. The processor then performs the search in the selected databases using the selected company names, and compares the data identified in the search with the user specified notification information to determine whether the specified type of change has occurred. If the change has occurred, then the processor transmits a notification to the user computer.

### BRIEF DESCRIPTION OF THE DRAWINGS

FIG. 1 is a block diagram of an example embodiment of a company database system;

FIG. 2 is an example embodiment of a server architecture;

FIG. 3 is a block diagram illustrating application interactions; and

FIGS. 4-19 illustrate example web pages for one embodiment of a company database system

### DETAILED DESCRIPTION OF THE INVENTION

Set forth below are descriptions of example embodiments of company database systems and methods that facilitate integrated network-based electronic reporting and workflow process management. The systems and methods facilitate, for example, electronic correlation of information stored within the system and extraction of such information.

More specifically, the systems and methods described herein correlate a variety of names under which a company might be identified in the same or different databases, internally and externally. The various names for a given company are linked together as a unit, stored at a specific location and assigned a unique identification number. All information relevant to this unit is linked to the unique ID, and as additional data relating to the company is entered, such additional data also is linked to the unique ID. Therefore, a next user requiring information on that entity can view the information already available regarding the entity before duplicating entry or research.

Once the data regarding a particular entity is linked as described above, the data can be fed to various reporting systems in place or later put in place across a company. In addition, and each time company data is accessed, the data is obtained from a same database location so that the same data is accessible and used across the company regardless of the function.

Providing a single access to internal information and at least some external information, such as ratings information, enhances consistency and facilitates preventing errors. In addition, a one-time entry of company information facilitates improving productivity by avoiding duplicate research and entries, and simplifying identification of comprehensive information.

Further, by linking the information as described above, the information can be automatically fed into the several reporting systems that use the information. Such systems and methods also facilitate automating alert notifications. Specifically, if a company rating changes, a rating alert can be automatically e-mailed to those who have requested such alerts. Such alerts facilitate improving efficiency since those impacted by rate changes are notified almost immediately of ratings changes.

In addition, the system will enable a user to select a portfolio of companies which the user desires to monitor. Specifically, a user can select a group of companies to monitor, and the system then generates a daily, weekly, and/or monthly e-mail notification sent to the user containing rating information stored in the database regarding the selected companies.

Set forth below are specific examples of systems and methods for correlating comprehensive company information stored in various databases. The systems and methods are described in the context of various company database and server systems. The systems and methods, however, are not limited to practice in any one particular database and server architecture and can be utilized in many different such architectures. In addition, there may be many different system architectures in place throughout any one single company.

Further, the systems and methods are sometimes described below in the context of data from ratings issuers such as Moodys Investors Services (commonly referred to as Moodys), KMV LLC (commonly referred to as KMV), and Standard & Poors (a division of the McGraw-Hill Companies and commonly referred to as S&P). The systems and methods, however, are not limited to practice with any one particular type of data and many other types of data in addition to ratings data can be employed in connection with such systems and methods.

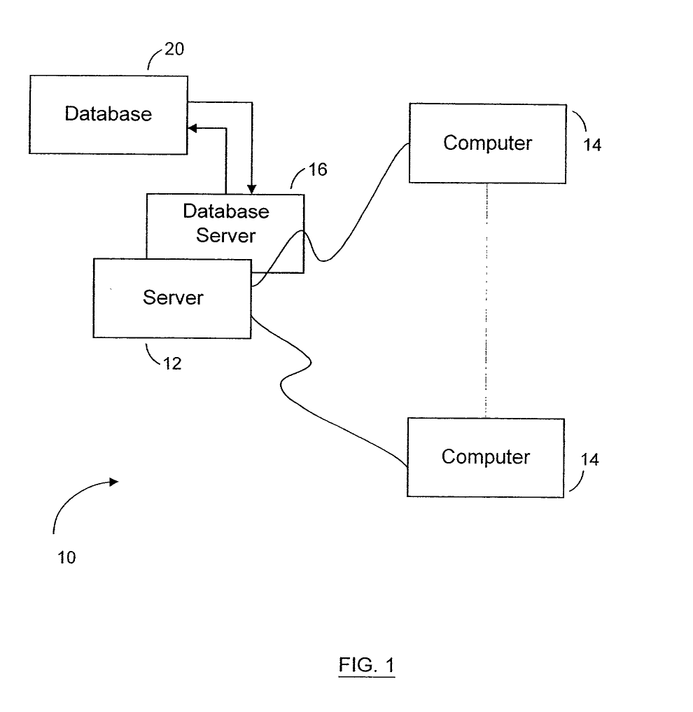

More particularly, FIG. 1 is a block diagram of a simple company database system 10 that includes a server sub-system 12, sometimes referred to herein as server 12, and a plurality of customer devices 14 connected to server 12. A particular company may have hundreds of systems 10 located throughout the company linked by a company Intranet (as described below). Ratings information may be stored in many of such systems 10, including ratings information for many of the same companies.

The correlation application, as described below in more detail, is stored in server 12 and can be accessed by a requester at any one of computers 14. In one embodiment, devices 14 are computers including a web browser, and server 12 is accessible to devices 14 via a network such as an intranet or a wide area network such as the Internet. In an alternative embodiment, devices 14 are servers for a network of customer devices. Customer device 14 could also be any client system capable of interconnecting to the Internet including a web based digital assistant, a web-based phone or other web-based connectable equipment. In another embodiment, server 12 is configured to accept information over a telephone, for example, at least one of a voice responsive system where a user enters spoken data, or by a menu system where a user enters a data request using the touch keys of a telephone as prompted by server 12.

Devices 14 are interconnected to the network, such as a local area network (LAN) or a wide area network (WAN), through many interfaces including dial-in-connections, cable modems and high-speed lines. Alternatively, devices 14 are any device capable of interconnecting to a network including a web-based phone or other web-based connectable equipment. Server 12 includes a database server 16 connected to a centralized database 20. In one embodiment, centralized database 20 is stored on database server 16 and is accessed by potential customers at one of customer devices 14 by logging onto server sub-system 12 through one of customer devices 14. In an alternative embodiment, centralized database 20 is stored remotely from server 12.

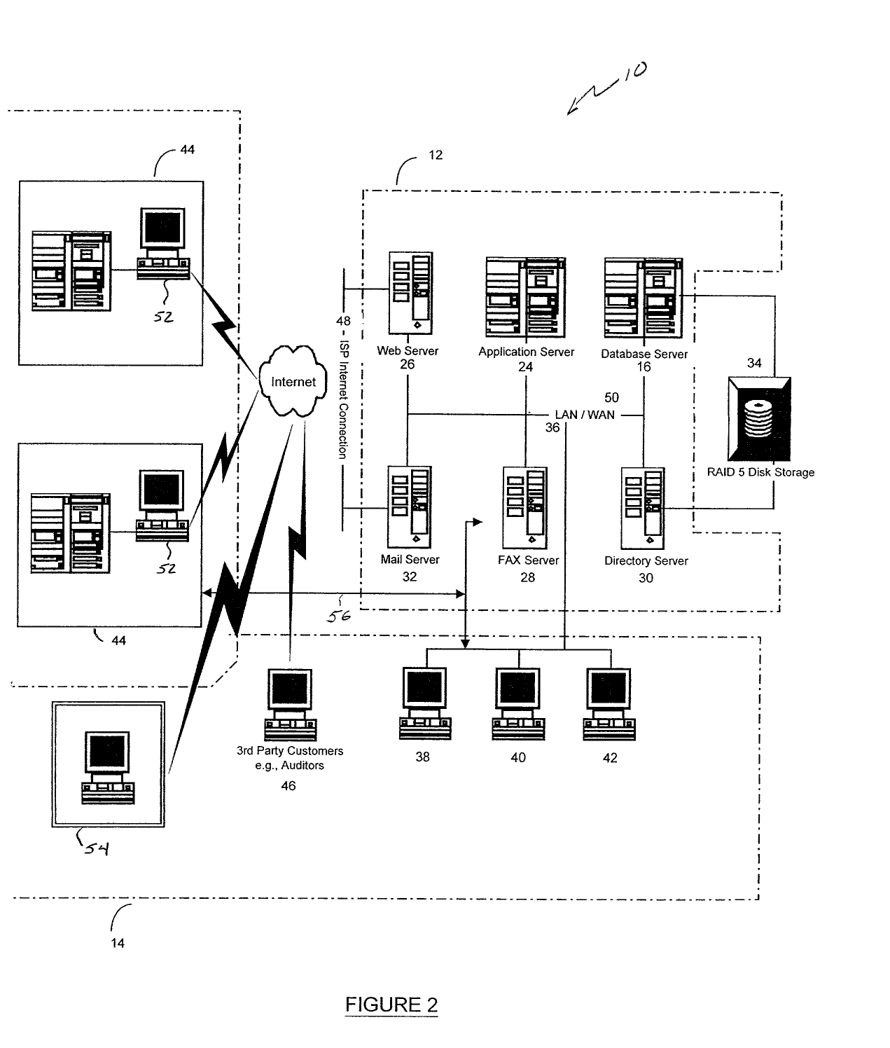

FIG. 2 is an expanded version block diagram of company database system 10. Components shown in FIG. 2 identical to components shown in FIG. 1 are identified in FIG. 2 using the same reference numerals used in FIG. 1. Again, system 10 includes server sub-system 12 and customer devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Server sub-system 12 is configured to be communicatively coupled to various individuals or employees 44 and to third parties, e.g., a customer 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the example embodiment, any employee 44 or customer 46 having a work station 52 can access server sub-system 12. One of customer devices 14 includes a work station 54 located at a remote location. Work stations 52 and 54 are personal computers including a web browser. Also, work stations 52 and 54 are configured to communicate with server sub-system 12. Furthermore, fax server 28 communicates with employees 44 and customers 46 located outside the business entity and any of the remotely located customer systems, including a customer system 56 via a telephone link. Fax server 28 is configured to communicate with other work stations 38, 40, and 42 as well.

As explained above, the architecture of system 10 as well as various components of system 10 are exemplary only. Other architectures are possible and can be utilized in connection with practicing the processes described below.

The database schema for the company database system is set forth in Appendix A. The data includes data designated as follows.

| | |
|---|---|
| Company.moodys: | data collected from the data feed from |
| | Moodys. |
| Company.sfg_moodys: | data stored in the business (in this example, |
| | the structured finance business (sfg)) |
| | database |
| Intranet.addresses: | the contact information for those employees |
| | who are to receive information from the |
| | system |
| Moody_xref: | cross reference between an issuer number, |
| | a ticker symbol, and a cusip |
| Company: | identification information for a particular |
| | company |
| Company.kmv: | identifiers for a particular company as |
| | used by KMV |
| Kmv_ratings: | the ratings assigned to a particular |
| | company by KMV |
| Kmv_ratings_comments: | comments added to or included within the |
| | KMV data |
| Kmv_edf_map: | correlation of KMV information stored in an |
| | electronic data file (edf) to memory locations |
| Kmv_edf_map_order: | sort KMV edf maps |
| Sfg_kmv_ratings: | company specific data obtained from KMV |
| SP_entity_identifiers: | S&P entity identifiers |
| Sp_entity_ratings: | ratings received from S&P |
| Sp_instrument_rating: | S&P instrument ratings |
| Sfg_sp_instrument ratings: | business specific data regarding the S&P |
| | instrument ratings |

In one embodiment, a unique identifier links all the different names under which one company is identified across all the company databases. In addition, data logic is utilized to determine which company databases to search and which company names to utilize in connection with the search, in response to a user request for data. For example, a company such as General Electric Company may be referenced in the many databases under 50 different company names. Each company name is linked to one unique identifier. That is, each unique company is assigned a unique company identifier which may be correlated with a plurality of names for that unique company. The linking can be generated manually and stored in system memory. For example, if General Electric Company is assigned a unique identifier of 10, then all the following company names may be linked to that unique identifier.

| | |
|---|---|
| Unique Identifier: | 10 |
| Company Names: | General Electric Company |
| | GENERAL ELECTRIC COMPANY |
| | GE |
| | GE Co. |
| | GE Co |
| | GE CO. |
| | GE CO |
| | General Electric Co. |

The unique identifier is then employed by the data logic in determining which databases to search in response to a particular request. For example, a first database may contain contact information and a second database may contain ratings information. If user inputs a search request for ratings information of General Electric Company, the data logic then causes a search to be executed in the second database using the company names linked to the unique identifier for General Electric Company. Similarly, if a user inputs a search request for contact information for General Electric Company, the data logic causes a search to be executed in the first database using the company names linked to the unique identifier for General Electric Company. Such linking and data logic are transparent to the user in that the user specifies the company to be searched (e.g., from a drop down menu) and the type of data desired. The system then determines which database to search and which of the different company names to utilize in connection with the search, and then returns the search results to the user.

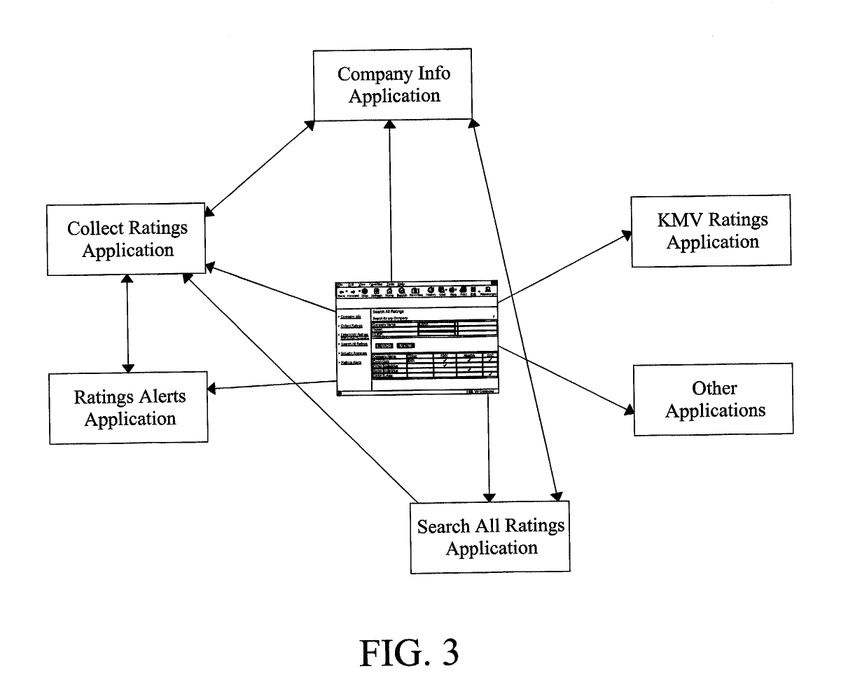

FIG. 3 is a block diagram illustrating example application interactions. As shown in FIG. 3, via a company database web page, a user can access many different applications. The purpose for this web page is to enable users to access different ‘applications’ within the company database system. The applications in this example include a company information (info) application, a KMV ratings application (which enables users to add in KMV ratings for companies), other applications, a search all ratings application, a ratings alerts application, and a collect ratings applications. As illustrated in FIG. 3, at least some of the applications have links to other applications so that data generated in the other applications can be utilized by that application.

A login process is utilized to determine an identity of the user. More specifically, a login web page is utilized for the login process, and the name of the user is passed through the login application so that the system can track who makes changes. The username dropdown logic is below.

| | |
|---|---|
| SELECT | (LastName ∥’, ‘∥ FirstName) UserName, AddressID |
| FROM | intranet.Addresses |
| WHERE | Business = ‘SFG’ |
| AND | DepartmentName <> ‘Conference Room’ |
| ORDER BY | LastName |

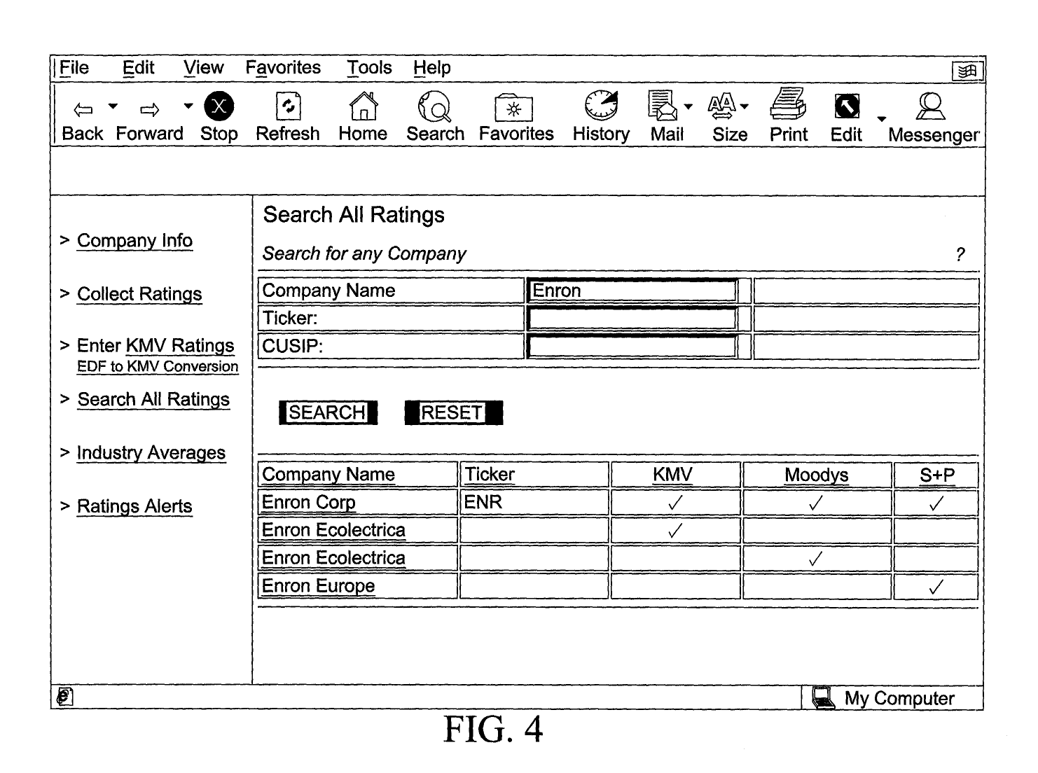

The login page links to a search all rating application that enables a user to search all ratings that are recorded in the database and all of the current ratings for companies listed in Moodys, S&P, and KMV, for example. Via the ratings_{search} page shown in FIG. 4, a user can search through the company table, as well as all of the ratings tables, for companies. The ratings that are available, by company, also can be obtained via this page. The bottom half of the page appears after the search button is selected. The page logic is below.

```
Page Creation Logic: (after search button is pressed)
IF CompanyName is entered THEN
  SELECT
company_id as COMPANY_ID,
company_name as COMPANY_NAME,
NVL(Company.ticker,‘ ’) as TICKER,
NVL(Kmv_pid,‘ ’) as KMV,
NVL(Moodys_issuer_nbr,‘ ’) as MOODY,
NVL(Standard_poors_nbr,‘ ’) as STANDARD_POOR
FROM company
WHERE (company.company_name) like UPPER(‘%a%’)
UNION
SELECT
0 as COMPANY_ID,
company_name as COMPANY_NAME,
NVL(ticker,‘ ’) as TICKER,
NVL(Kmv_pid,‘ ’) as KMV,
‘ ’ as MOODY,
‘ ’ as STANDARD_POOR
FROM kmv
WHERE (company_name) like UPPER(‘%a%’)
AND kmv_pid not in (select kmv_pid from company)
UNION
SELECT
distinct 0 as COMPANY_ID,
organization_name as COMPANY_NAME,
NVL(Ticker,‘ ’) as TICKER,
‘ ’ as KMV,
moodys.moodys_issuer_nbr as MOODY,
‘ ’ as STANDARD_POOR
FROM moodys, moody_xref
WHERE moodys.moodys_issuer_nbr = moody_xref.moodys_issuer_nbr (+)
AND (organization_name) like UPPER(‘%a%’)
AND moodys.moodys_issuer_nbr not in (select distinct moodys_issuer_nbr from
company)
UNION
SELECT
distinct 0 as COMPANY_ID,
entity_name as COMPANY_NAME,
NVL(Ticker,‘ ’) as TICKER,
‘ ’ as KMV,
‘ ’ as MOODY,
entity_id as STANDARD_POOR
FROM sp_entity_identifiers
WHERE (entity_name) like UPPER(‘%a%’)
AND entity_id not in (select distinct standard_poors_nbr from company)
IF ticker is entered THEN
SELECT company_id as COMPANY_ID,
  company_name as COMPANY_NAME,
  NVL(ticker,‘ ’) as TICKER,
  NVL(Kmv_pid,‘ ’) as KMV,
  NVL(Moodys_issuer_nbr,‘ ’) as MOODY,
  NVL(Standard_poors_nbr,‘ ’) as STANDARD_POOR
FROM company
WHERE UPPER(ticker) like UPPER(‘%a%’)
UNION
SELECT 0 as COMPANY_ID,
  company_name as COMPANY_NAME,
  NVL(ticker,‘ ’) as TICKER,
  NVL(Kmv_pid,‘ ’) as KMV,
  ‘ ’ as MOODY,
  ‘ ’ as STANDARD_POOR
FROM kmv
WHERE UPPER(ticker) like UPPER(‘%a%’)
AND kmv_pid not in (select kmv_pid from company)
UNION
SELECT distinct 0 as COMPANY_ID,
  organization_name as COMPANY_NAME,
  NVL(Ticker,‘ ’) as TICKER,
  ‘ ’ as KMV,
  moodys.moodys_issuer_nbr as MOODY,
  ‘ ’ as STANDARD_POOR
FROM moodys,moody_xref
WHERE moodys.moodys_issuer_nbr = moody_xref.moodys_issuer_nbr (+)
AND UPPER(moody_xref.ticker) like UPPER(‘%a%’)
AND moodys.moodys_issuer_nbr not in (select distinct moodys_issuer_nbr from
company)
UNION
SELECT
distinct 0 as COMPANY_ID,
entity_name as COMPANY_NAME,
NVL(Ticker,‘ ’) as TICKER,
‘ ’ as KMV, ‘ ’ as MOODY,
NVL(entity_id,‘ ’) as STANDARD_POOR
FROM sp_entity_identifiers
WHERE UPPER(ticker) like UPPER(‘%a%’)
AND entity_id not in (select distinct standard_poors_nbr from company)
IF CUSIP entered
SELECT distinct NVL(c.company_id,0) as COMPANY_ID,
decode(c.company_name,null,s.entity_name,c.company_name) as
COMPANY_NAME,
NVL(s.Ticker,‘ ’) as TICKER,
NVL(c.kmv_pid,‘ ’) as KMV,
‘ ’ as MOODY,
NVL(s.entity_id,‘ ’) as STADARD_POOR
FROM sp_entity_identifiers s, company c
WHERE UPPER(s.cusip) like UPPER(‘%a%’) AND s.entity_id =
c.standard_poors_nbr (+)
MINUS
SELECT
Distinct NVL(c.company_id,0) as COMPANY_ID,
decode(c.company_name,null,m.organization_name,c.company_name) as
COMPANY_NAME,
NVL(decode(x.Ticker,null,c.ticker,x.ticker),‘ ’) as TICKER,
NVL(c.kmv_pid,‘ ’) as KMV,
NVL(m.moodys_issuer_nbr,‘ ’) as MOODY,
‘ ’ as STANDARD_POOR
FROM moodys m,company c,moody_xref x
WHERE UPPER(m.cusip) like UPPER(‘%a%’)
AND m.moodys_issuer_nbr = c.moodys_issuer_nbr (+)
AND m.moodys_issuer_nbr = x.moodys_issuer_nbr (+)
If CompanyName and Ticker are entered,
SELECT company_id as COMPANY_ID,
company_name as COMPANY_NAME,
NVL(ticker,‘ ’) as TICKER,
NVL(Kmv_pid,‘ ’) as KMV,
NVL(Moodys_issuer_nbr,‘ ’) as MOODY,
NVL(Standard_poors_nbr,‘ ’) as STANDARD_POOR
FROM company
WHERE (company.company_name) like UPPER(‘%a%’)
AND UPPER(ticker) like UPPER(‘%a%’)
UNION
SELECT
0 as COMPANY_ID,
company_name as COMPANY_NAME,
NVL(ticker,‘ ’) as TICKER,
Kmv_pid as KMV,
‘ ’ as MOODY,
‘ ’ as STANDARD_POOR
FROM kmv
WHERE company_name like UPPER(‘%a%’)
  AND UPPER(ticker) like UPPER(‘%a%’) AND kmv_pid not in (select kmv_pid from
company)
UNION
SELECT
distinct 0 as COMPANY_ID,
organization_name as COMPANY_NAME,
NVL(Ticker,‘ ’) as TICKER,
‘ ’ as KMV,
moodys.moodys_issuer_nbr as MOODY,
‘ ’ as STANDARD_POOR
FROM moodys,moody_xref
WHERE (organization_name) like UPPER(‘%a%’)
AND moodys.moodys_issuer_nbr = moody_xref.moodys_issuer_nbr (+)
AND UPPER(moody_xref.ticker) like UPPER(‘%a%’)
AND moodys.moodys_issuer_nbr not in (select distinct moodys_issuer_nbr from
company)
UNION
SELECT
distinct 0 as COMPANY_ID,
entity_name as COMPANY_NAME,
NVL(Ticker,‘ ’) as TICKER,
‘ ’ as KMV,
‘ ’ as MOODY,
entity_id as STANDARD_POOR
FROM sp_entity_identifiers
WHERE (entity_name) like UPPER(‘%a%’)
AND UPPER(ticker) like UPPER(‘%a%’)
AND entity_id not in (select distinct standard_poors_nbr from company)
If Company Name + Cusip are entered, then
SELECT
distinct NVL(c.company_id,0) as COMPANY_ID,
decode(c.company_name,null, s.entity_name,c.company_name) as
COMPANY_NAME,
NVL(s.Ticker,‘ ’) as TICKER,
NVL(c.kmv_pid,‘ ’) as KMV,
‘ ’ as MOODY,
s.entity_id as STANDARD_POOR
FROM sp_entity_identifiers s,company c
WHERE UPPER(s.cusip) like UPPER(‘%a%’)
AND (c.company_name like UPPER(‘%a%’) or s.entity_name like UPPER(‘%a%’))
AND s.entity_id = c.standard_poors_nbr (+)
MINUS
SELECT
distinct NVL(c.company_id,0) as COMPANY_ID,
decode(c.company_name,null,m.organization_name,c.company_name) as
COMPANY_NAME,
NVL(decode(x.Ticker,null,c.ticker,x.ticker),‘ ’) as TICKER,
NVL(c.kmv_pid,‘ ’) as KMV,
m.moodys_issuer_nbr as MOODY,
‘ ’ as STANDARD_POOR
FROM moodys m,company c,moody_xref x
WHERE UPPER(m.cusip) like UPPER(‘%a%’)
AND ( c.company_name like UPPER(‘%a%’) or m.organization_name like
UPPER(‘%a%’))
AND m.moodys_issuer_nbr = c.moodys_issuer_nbr (+)
AND m.moodys_issuer_nbr = x.moodys_issuer_nbr (+)
IF COMPANY NAME, CUSIP and TICKER are entered, then
SELECT
distinct NVL(c.company_id,0) as COMPANY_ID,
decode(c.company_name,null,s.entity_name,c.company_name) as
COMPANY_NAME,
NVL(s.Ticker,‘ ’) as TICKER,
NVL(c.kmv_pid,‘ ’) as KMV,
‘ ’ as MOODY,
s.entity_id as STANDARD_POOR
FROM sp_entity_identifiers s,
  company c
WHERE UPPER(s.cusip) like UPPER(‘%a%’)
AND (c.company_name like UPPER(‘%a%’) OR s.entity_name like UPPER(‘%a%’))
AND (UPPER(c.ticker) like UPPER(‘%a%’) or UPPER(s.ticker) like UPPER(‘%a%’))
AND s.entity_id = c.standard_poors_nbr (+)
MINUS
SELECT
distinct NVL(c.company_id,0) as COMPANY_ID,
  decode(c.company_name,null,m.organization_name,c.company_name) as
COMPANY_NAME,
  NVL(decode(x.Ticker,null,c.ticker,x.ticker),‘ ’) as TICKER,
  NVL(c.kmv_pid,‘ ’) as KMV,
  m.moodys_issuer_nbr as MOODY,
  ‘ ’ as STANDARD_POOR
FROM moodys m,
  company c,
  moody_xref x
WHERE UPPER(m.cusip) like UPPER(‘%a%’)
AND (c.company_name like UPPER(‘%a%’) or m.organization_name like
UPPER(‘%a%’))
AND (UPPER(c.ticker) like UPPER(‘%a%’) or UPPER(c.ticker) like UPPER(‘%a%’))
AND m.moodys_issuer_nbr= c.moodys_issuer_nbr (+) AND m.moodys_issuer_nbr
= x.moodys_issuer_nbr (+)
IF CUSIP and TICKER are entered, then
SELECT
distinct NVL(c.company_id,0) as COMPANY_ID,
decode(c.company_name,null,s.entity_name,c.company_name) as
COMPANY_NAME,
NVL(s.Ticker,‘ ’) as TICKER,
NVL(c.kmv_pid,‘ ’) as KMV,
‘ ’ as MOODY,
s.entity_id as STANDARD_POOR
FROM sp_entity_identifiers s,
  company c
WHERE (UPPER(c.ticker) like UPPER(‘%a%’) r UPPER(s.ticker) like
UPPER(‘%a%’))
AND UPPER(s.cusip) like UPPER(‘%a%’) AND s.entity_id = c.standard_poors_nbr
(+)
MINUS
SELECT
distinct NVL(c.company_id,0) as COMPANY_ID,
decode(c.company_name,null,m.organization_name,c.company_name) as
COMPANY_NAME,
NVL(decode(c.Ticker,null,x.ticker,c.ticker),‘ ’) as TICKER,
NVL(c.kmv_pid,‘ ’) as KMV,
m.moodys_issuer_nbr as MOODY,
‘ ’ as STANDARD_POOR
FROM moodys m, company c, moody_xref x
WHERE (UPPER(c.ticker) like UPPER(‘%a%’) or UPPER(c.ticker) like
UPPER(‘%a%’))
AND UPPER(m.cusip) like UPPER(‘%a%’)
AND m.moodys_issuer_nbr= c.moodys_issuer_nbr (+) AND m.moodys_issuer_nbr
= x.moodys_issuer_nbr (+)
IF kmv_pid is NOT blank THEN insert checkmark under KMV
IF moodys_issuer_nbr is NOT blank THEN insert checkmark under Moodys
IF standard_poors_nbr is NOT blank THEN insert checkmark under S+P
Validation:
  ON submit IF form.company_name AND form.ticker AND form.cusip is
NULL THEN issue a warning
  Do a count of records returned before displaying them. If count > 500, issue
message “Please refine your search criteria” and take them back to the search screen.
```

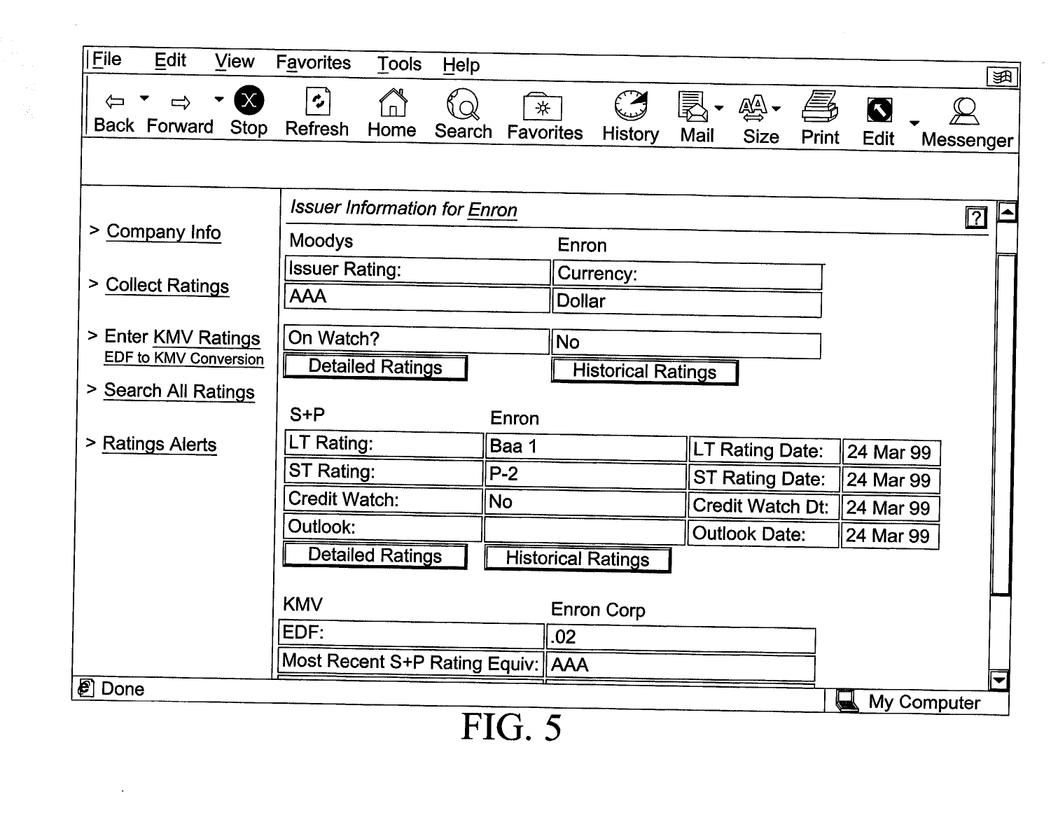

FIG. 5 illustrates an example current page that provides a user with a snapshot for the ratings information of a given company. The logic for this page is below.

IF exist moodys_issuer_nbr THEN

| | |
|---|---|
| SELECT | distinct organization_name, |

current_rating ∥’ ‘∥rating_type,
currency

| FROM moodys | |
|---|---|
| WHERE | debt_class = ‘CTP’ |
| AND moodys_issuer_nbr = form.moodys_issuer_nbr | |
| SELECT | count(*) |
| FROM moodys | |
| WHERE | watchlist_indicator = ‘ON’ |
| AND moodys_issuer_nbr = form.moodys_issuer_nbr | |
| IF count > 0 THEN On Watch = Y ELSE On Watch = N | |
| CREATE | detailed ratings button LINK to current_moody passing |

moodys_issuer_nbr

| | |
|---|---|
| IF EXIST | companyid THEN |
| CREATE | historical ratings button LINK to history_moody passing |

companyid, moodys_issuer_nbr

IF exist standard_poor_nbr THEN

| | |
|---|---|
| SELECT | entity_name |

LT_rating,
LT_rating_date,
ST_rating,
ST_rating_date,
Creditwatch,
Creditwatch_date,
Outlook,
Outlook_date,

| FROM sp_entity_ratings | |
|---|---|
| WHERE | entity_id = form.standard_poor_nbr |
| CREATE | detailed ratings button LINK to current_sp passing |

standard_poor_nbr

| | |
|---|---|
| IF Exist | companyid THEN |
| CREATE | historical ratings button LINK to history_sp passing |

companyid, standard_poor_nbr
IF EXIST kmv_pid THEN

IF companyid is NOT blank THEN
SELECT

company.company_name as

COMPANY_NAME,

sfg_kmv_ratings.company_id as

COMPANY_ID,

nvl(sfg_kmv_ratings.kmv_pid, ”)as KMV_PID,
nvl(sfg_kmv_ratings.edf_rating, ”)as

EDF_RATING,

to_char(sfg_kmv_ratings.generated_date,

‘mm/dd/yyyy’)as GENERATED_DATE,

nvl(sfg_kmv_ratings.generated_by, ‘ ’)as

GENERATED_BY,

nvl(kmv_edf_map.rating, ‘ ’)as RATING
FROM sfg_kmv_ratings,
company,
kmv_edf_map

WHERE

company.company_id = form.Company_id

AND company.company_id =

sfg_kmv_ratings.company_id

AND sfg_kmv_ratings.generated_date =
(select Max(c.generated_date) from

sfg_kmv_ratings c where c.company_id
=sfg_kmv_ratings.company_id)

AND kmv_edf_map.effective_date =
(select max(d.effective_date) from

kmv_edf_map d )

AND sfg_kmv_ratings.edf_rating
between kmv_edf_map.edf_lower and

kmv_edf_map.edf_upper

AND sfg_kmv_ratings.edf_rating <> 0

union
SELECT

company.company_name as

COMPANY_NAME,

sfg_kmv_ratings.company_id as

COMPANY_ID,

nvl(sfg_kmv_ratings.kmv_pid, ”)as KMV_PID,
nvl(sfg_kmv_ratings.edf_rating, ”)as

EDF_RATING,

to_char(sfg_kmv_ratings.generated_date,

‘mm/dd/yyyy’)as GENERATED_DATE,

nvl(sfg_kmv_ratings.generated_by, ‘ ’)as

GENERATED_BY,

nvl(sfg_kmv_ratings.kmv_rating, ‘ ’)as

RATING

FROM sfg_kmv_ratings,
company
WHERE company.company_id =

form.company_id

AND company.company_id =

sfg_kmv_ratings.company_id

AND sfg_kmv_ratings.generated_date =
(select Max(c.generated_date) from

sfg_kmv_ratings c where c.company_id
=sfg_kmv_ratings.company_id)

AND sfg_kmv_ratings.edf_rating = 0

| CREATE | historical ratings button LINK to history_kmv passing |
|---|---|
| companyid, kmv_pid | |
| CREATE | detailed ratings button LINK to kmv_ratings_detail |

passing companyid, kmv_pid

IF companyid IS blank THEN
SELECT

kmv.company_name as COMPANY_NAME,
0 as COMPANY_ID,
kmv.kmv_pid as KMV_PID,
nvl(kmv_ratings.edf_rating, ”)as EDF_RATING,
to_char(nvl(kmv_ratings.generated_date,sysdate), ‘mm/dd/yyyy’)as

GENERATED_DATE,

‘KMV’ as GENERATED_BY,
nvl(kmv_edf_map.rating, ‘ ’)as RATING
FROM kmv , kmv_ratings,

kmv_edf_map

WHERE kmv.kmv_pid = form.kmv_pid
AND kmv.kmv_pid = kmv_ratings.kmv_pid
AND kmv_ratings.generated_date =
(select Max(c.generated_date) from kmv_ratings c where c.kmv_pid

=kmv_ratings.kmv_pid)

| and kmv_edf_map.effective_date = | |
|---|---|
| (select max(d.effective_date) from kmv_edf_map d ) | |
| and kmv_ratings.edf_rating | |
| between kmv_edf_map.edf_lower and kmv_edf map.edf_upper | |
| CREATE | detailed ratings button LINK to kmv_ratings_detail passing |

kmv_pid

| | |
|---|---|
| CREATE | historical ratings button LINK to history_kmv passing kmv_pid |

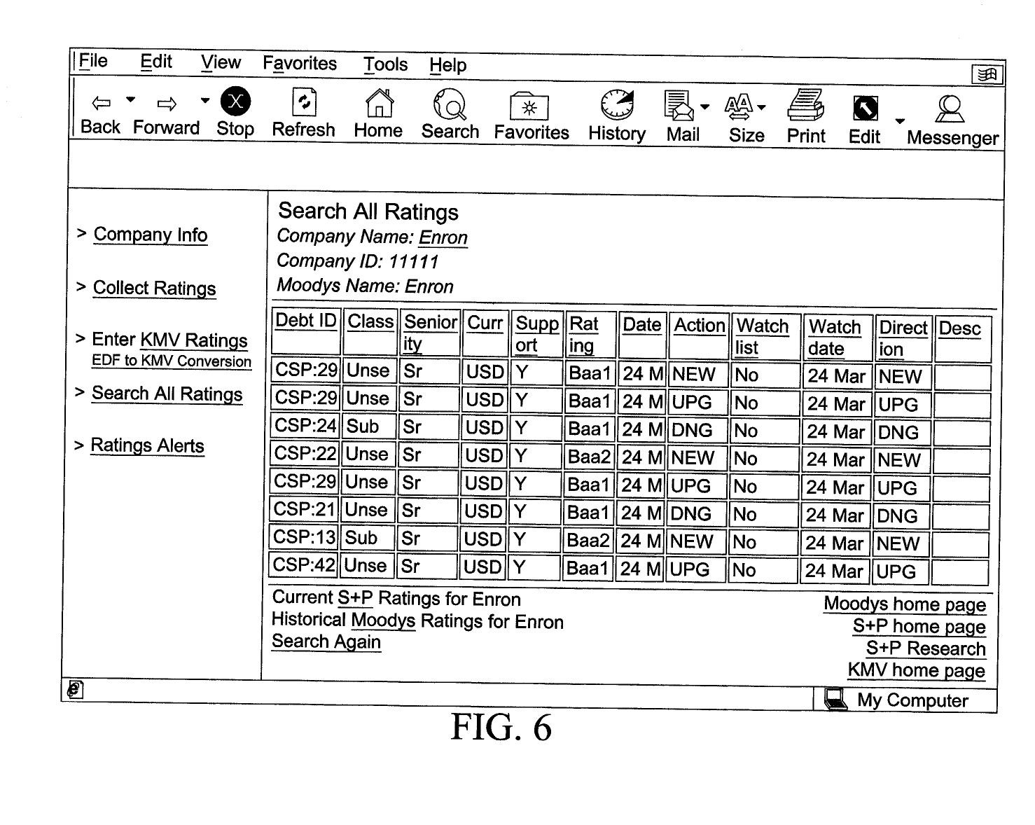

FIG. 6 illustrates an example page for displaying all the different current ratings that a particular company has within Moodys. The page also has links at the bottom of the page to facilitate navigation. Logic for this page is below.

```
Page Creation Logic:
  Each column is sortable. An up or down arrow in each table header
  indicates
current sort order
    SELECT  nvl(Cusip,‘ ’) as CUSIP,
        nvl(Isin,‘ ’) as ISIN,
        nvl(Debt_class,‘ ’) as DEBT_CLASS,
        nvl(Seniority,‘ ’) as SENIORITY,
        NVL(‘Cpn -’ ∥ Coupon ∥ ‘ Mat -’ ∥ maturity_date,‘ ’) as
    COUPON,
        nvl(Currency,‘ ’) as CURRENCY,
        nvl(Support,‘ ’) as SUPPORT,
        nvl(Current_Rating,‘ ’) as CURRENT_RATING,
        to_char(nvl(Rating_date,sysdate), ‘mm/dd/yyyy’)as
    RATING_DATE,
        nvl(Rating_direction,‘ ’) as RATING_DIRECTION,
        nvl(Watchlist_indicator,‘ ’) as
    WATCHLIST_INDICATOR,
        to_char(nvl(Watchlist_date,sysdate), ‘mm/dd/yyyy’)as
    WATCHLIST_DATE,
        nvl(Watchlist_reason,‘ ’) as WATCHLIST_REASON
        FROM moodys
        WHERE
        moodys_issuer_nbr = form.moodys_issuer_nbr
    When displaying the results:
      If cusip is not blank, display the literal CSP: concatenated with the
    field cusip
    Else
      If isin is not blank, display the literal ISN: concatenated with the
      field
    isin
Detailed_sp link:
  IF EXIST companyid AND standard_poors_nbr THEN CREATE
  detailed_sp
link passing companyid and standard_poors_nbr
Historical Moodys link:
  IF EXIST companyid and moodys_issuer_nbr THEN CREATE
historical_moody link passing companyid and moodys_issuer_nbr
Moodys home page link:
  Links to http://www.moodys.com
S+P home page link:
  Links to http://www.standardandpoors.com
S+P research link:
  Links to http://www.standardandpoors.com/ratingsdirect
KMV homepage link:
  Links to http://www.kmv.com
“Search Again” logic:
  Link to ratings_search
```

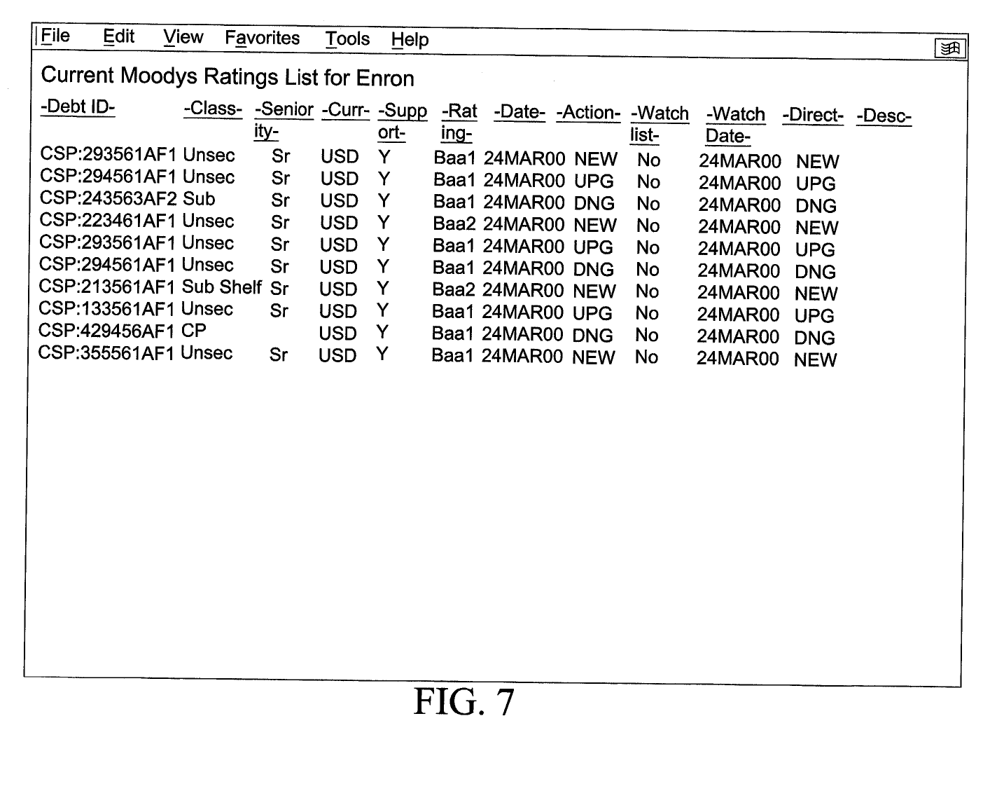

FIG. 7 illustrates an example page on which the data from the detailed_moody page (FIG. 6) is presented in a different format (e.g., Excel, Word). A dialog box can pop up with the legend “Please click on File and then Print”

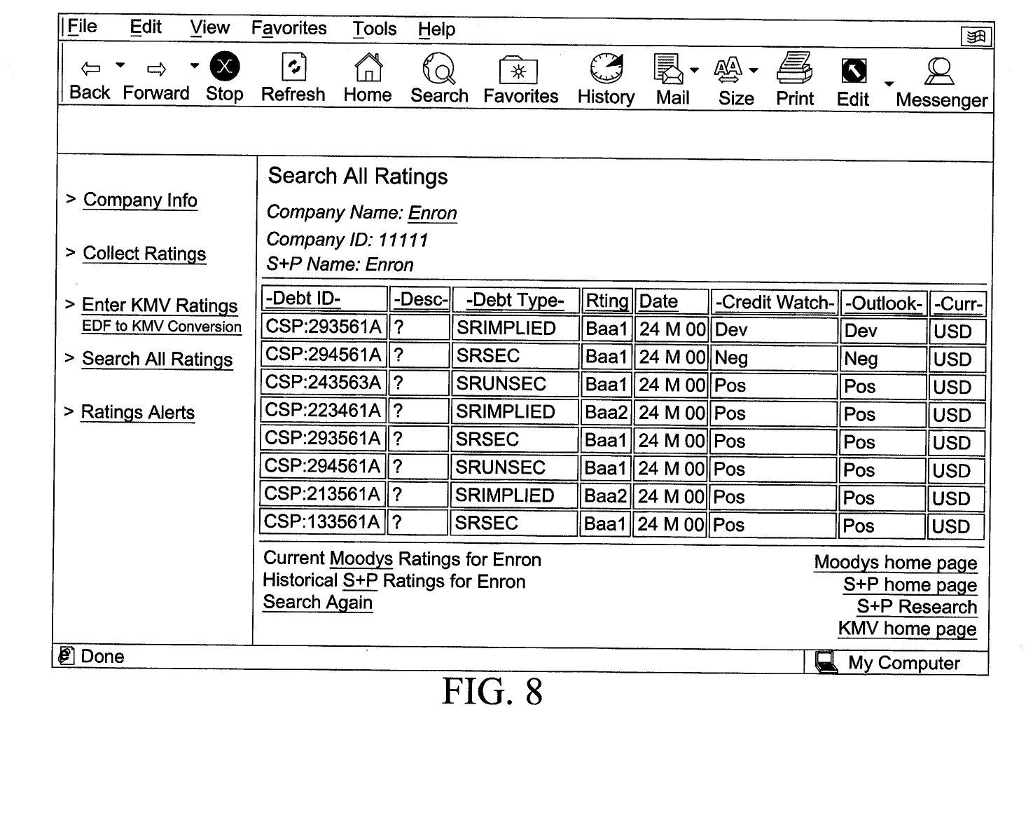

FIG. 8 illustrates an example detailed_sp page that shows all of the different current ratings that a particular company has within the Standards & Poors index, and the data can be displayed in a different format (e.g., Excel, Word). This page has links at the bottom to facilitate navigation. The page logic is below.

```
Page Creation Logic:
  Each column is searchable. Include an up or down arrow in each table
  header
to indicate current sort order
    SELECT
        nvl(Cusip,‘ ’) as CUSIP,
        nvl(Isin,‘ ’) as ISIN,
        nvl(Instrument_name,‘ ’) as INSTRUMENT_NAME,
        nvl(Instrument_type,‘ ’) as INSTRUMENT_TYPE,
        nvl(Instrument_rating,‘ ’) as INSTRUMENT_RATING,
        to_char(nvl(Instrument_rating_date,sysdate),
    ‘mm/dd/yyyy’)as INSTRUMENT_RATING_DATE,
        nvl(Instrument_creditwatch,‘ ’) as
    INSTRUMENT_CREDITWATCH,
        nvl(Instrument_outlook,‘ ’) as
    INSTRUMENT_OUTLOOK,
        nvl(Currency_type_code,‘ ’) as
    CURRENCY_TYPE_CODE
        FROM sp_detailed_ratings
        WHERE entity_id = form.standard_poor_nbr
    When displaying the results:
    IF cusip is not blank, display the literal CSP: concatenated with the
    field cusip
    ELSE
  IF isin is not blank, display the literal ISN: concatenated with the field
  isin
Detailed_moody link:
  IF EXIST moodys_issuer_nbr THEN CREATE detailed_moody
  link passing
moodys_issuer_nbr
Historical sp link:
  IF EXIST standard_poors_nbr THEN CREATE historical_sp link
  passing
standard_poors_nbr
Moodys home page link:
  Links to http://www.moodys.com
S+P research link:
  Links to http://www.standardandpoors.com/ratingsdirect
S+P home page link:
  Links to http://www.standardandpoors.com
KMV homepage link:
  Links to http://www.kmv.com
“Search Again” logic:
  Link to ratings_search
```

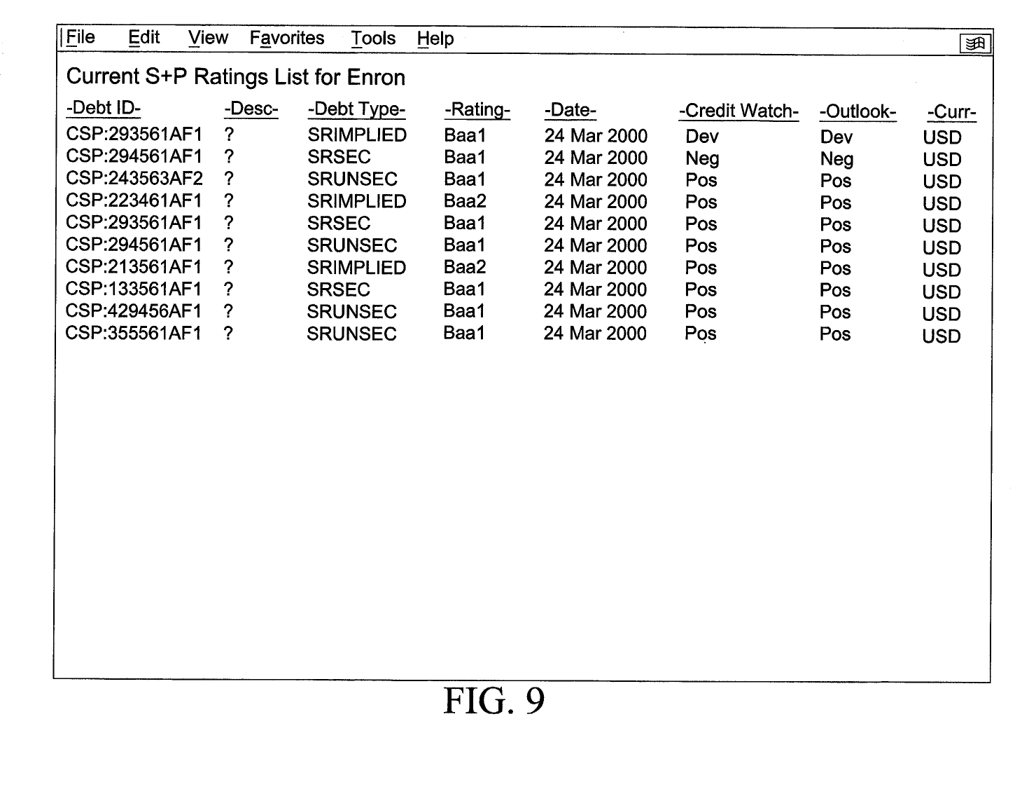

FIG. 9 illustrates an example detailed_sp_printable page. This page takes uses the same data from the detailed_sp page and presents that data in a different format (e.g., Excel, Word). A dialog box should pop up with the legend “Please click on File and then Print”.

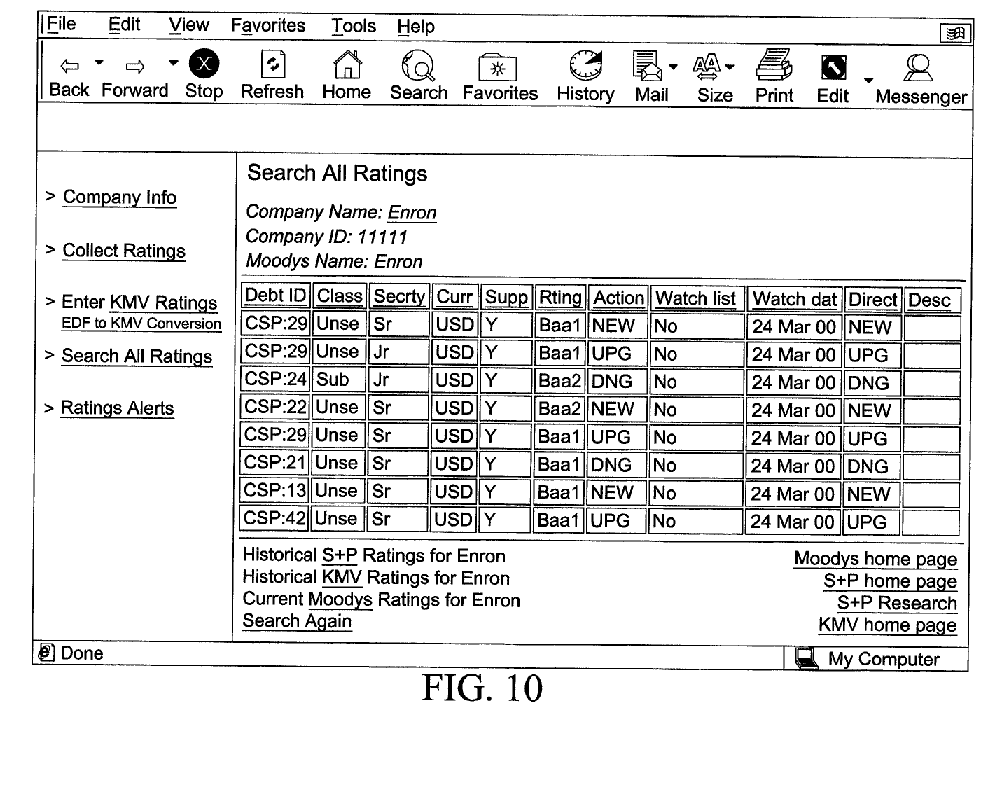

FIG. 10 is an example history_moody page that shows the historical rating that a particular company has within Moodys. These ratings are available for companies that have a moodys_issuer_nbr in the master table and the data can be displayed in a different format (e.g., Excel, Word). This page also has links at the bottom of the page to facilitate navigation. The logic for this page is below.

```
Page Creation Logic:
  Make each column sortable. Include an up or down arrow in each table
  header
to indicate current sort order
  SELECT effective_date,
        Cusip,
        Isin,
        Debt_class,
        Seniority,
        ‘Cpn - ’ ∥ Coupon ∥ ‘ Mat - ’ ∥ maturity_date,
        Currency,
        Support,
        Current_Rating,
        Rating_date,
        Rating_direction,
        Watchlist_indicator,
        Watchlist_date,
        Watchlist_reason
    FROM sfg_moodys
    WHERE company_id = form.company_id
    ORDER BY effective_date desc
    When displaying the results:
    IF cusip is not blank, display the literal CSP: concatenated with the
    field cusip
    ELSE
    IF isin is not blank, display the literal ISN: concatenated with the
    field
    isin
history_sp link:
  IF EXIST standard_poors_nbr THEN create link history_sp passing
standard_poors_nbr and companyid
history_kmv link:
  IF EXIST kmv_pid THEN create link history_kmv passing kmv_pid
  and
companyid
Current Moodys link
  link to detailed_moody passing moodys_issuer_nbr
“Search Again” Button:
  Link to ratings_search
Moodys home page link:
Links to http://www.moodys.com
S+P research link:
http://www.standardandpoors.com/ratingsdirect
Links to S+P home page link:
  Links to http://www.standardandpoors.com
KMV homepage link:
  Links to www.kmv.com
```

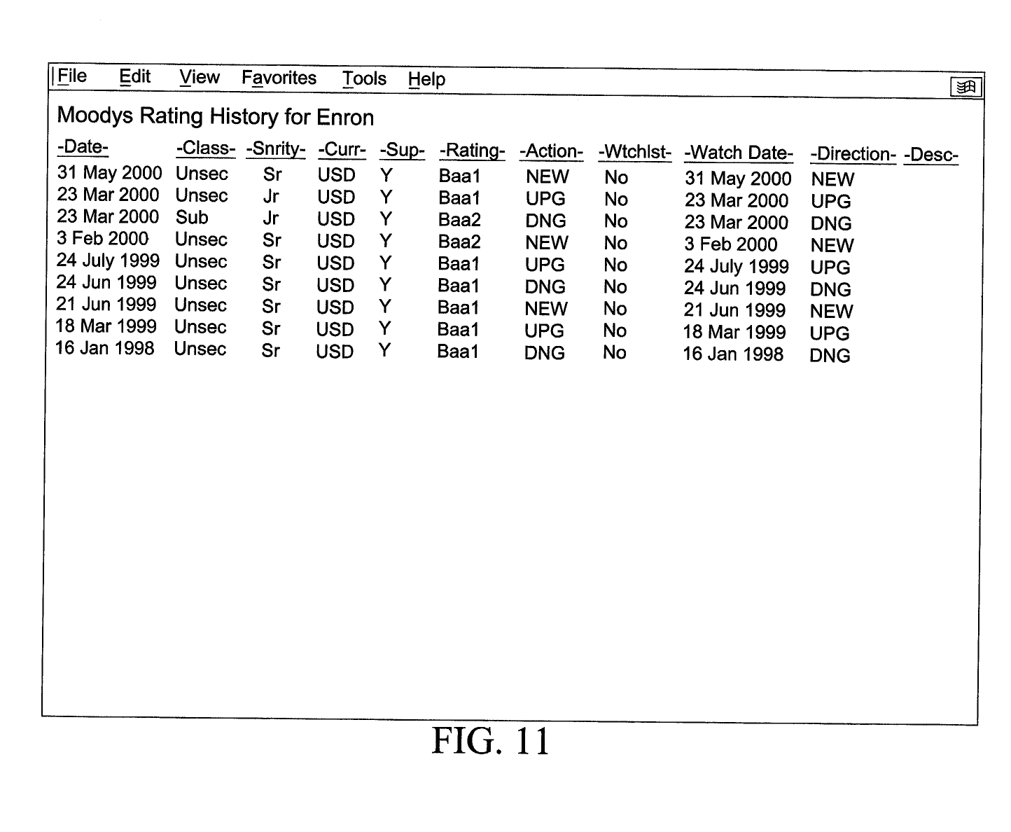

FIG. 11 illustrates an example history_moody_printable page. This page uses the same data from the history_moody page and presents the data in a different format (e.g., Excel, Word). A dialog box pops up with the legend “Please click on File and then Print”.

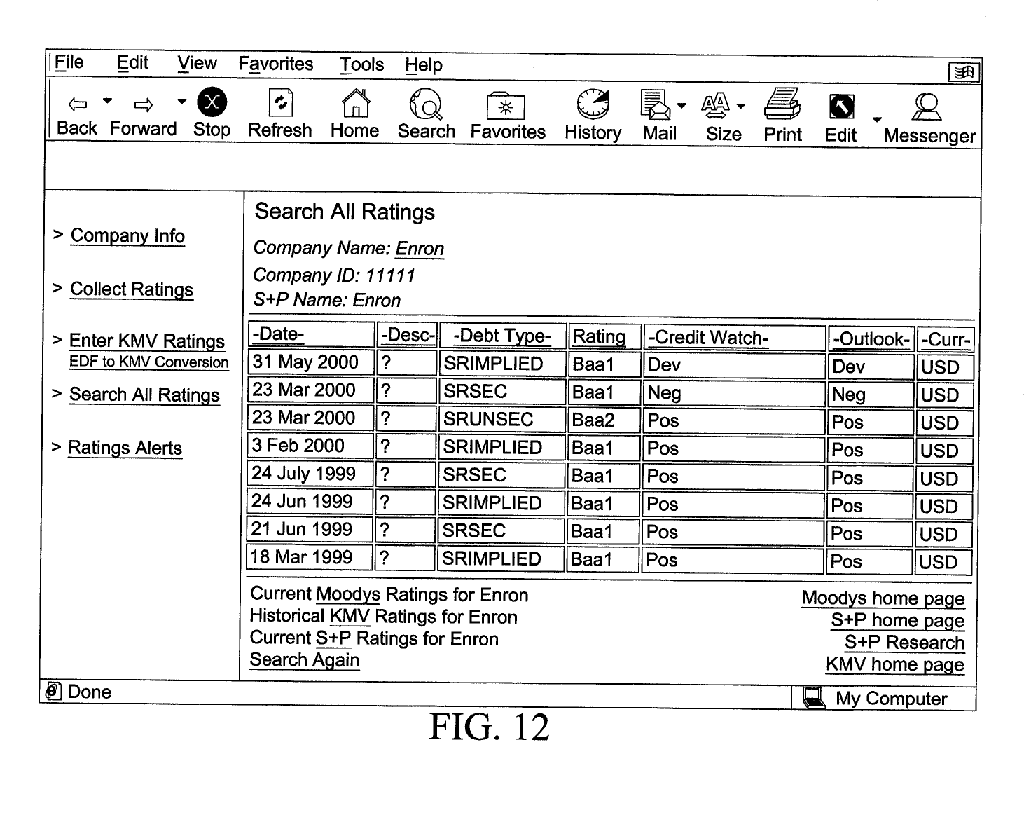

FIG. 12 illustrates an example history_sp page that shows the historical rating that a particular company has within the S&P. These ratings are only available for companies that have a standard_poors_nbr in the master table. This page also has links to facilitate navigation. Logic for this page is below.

```
Page Creation Logic:
  Each column is searchable. An up or down arrow is in each table header
  to
indicate current sort order
    SELECT
    effective_date as EFFECTIVE_DATE,
    nvl(cusip,‘ ’) as CUSIP,
    nvl(Isin,‘ ’) as ISIN,
    nvl(Instrument_name,‘ ’) as INSTRUMENT_NAME,
    nvl(Instrument_type,‘ ’) as INSTRUMENT_TYPE,
    nvl(Instrument_rating,‘ ’) as INSTRUMENT_RATING,
    nvl(Instrument_rating_date,‘ ’) as INSTRUMENT_RATING_{—}
    DATE,
    nvl(Instrument_creditwatch,‘ ’) as INSTRUMENT_CREDIT_{—}
    WATCH,
    nvl(Instrument_outlook,‘ ’) as INSTRUMENT_OUTLOOK,
    nvl(Currency_type_code,‘ ’) as CURRENCY_TYPE_CODE
    FROM sp_historical_ratings
    WHERE company_id = form.Company ID ORDER BY
    effective_date desc
    When displaying the results:
    IF cusip is not blank, display the literal CSP: concatenated with the
    field cusip
    ELSE
    IF isin is not blank, display the literal ISN: concatenated with the
    field
    isin
history_moody link:
  IF EXIST moodys_issuer_nbr THEN create link history_moody
  passing
moodys_issuer_nbr and companyid
history_kmv link:
  IF EXIST kmv_pid THEN create link history_kmv passing kmv_pid
  and
companyid
Current S+P link
  link to detailed_sp passing standard_poors_nbr
“Search Again” Button:
  Link to ratings_search
Moodys home page link:
  Links to http://www.moodys.com
S+P research link:
  Links to http://www.standardandpoors.com/ratingsdirect
S+P home page link:
  Links to http://www.standardandpoors.com
KMV homepage link:
  Links to http://www.kmv.com
```

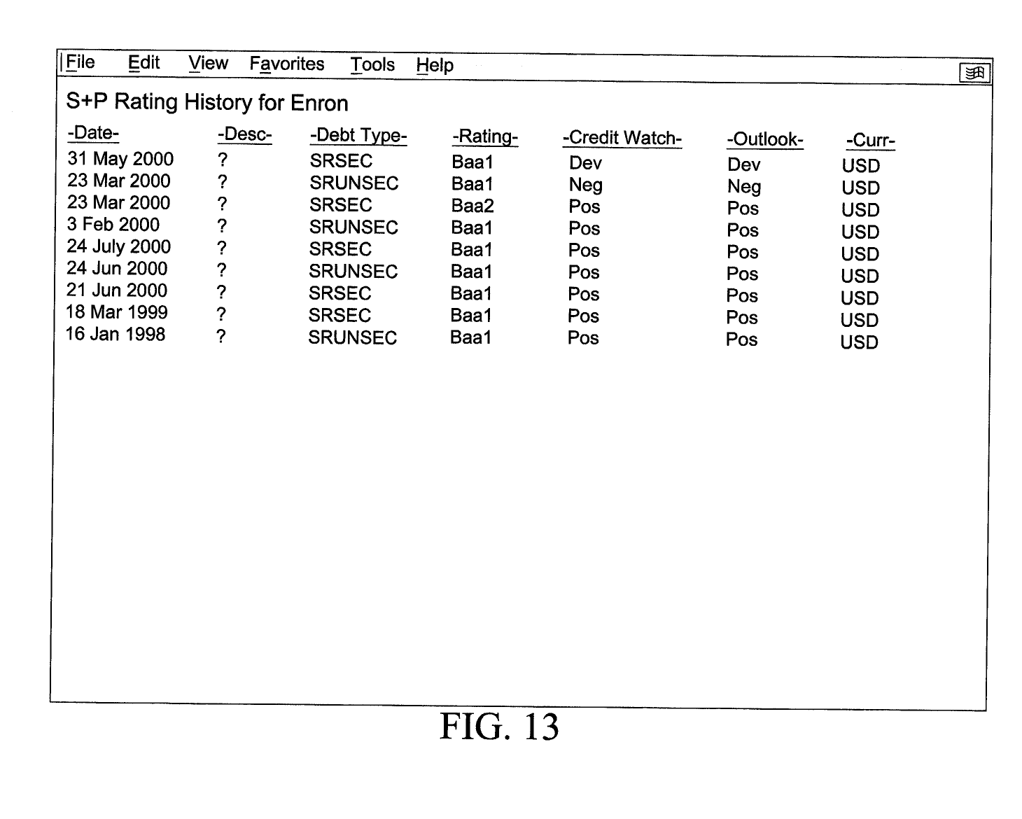

FIG. 13 illustrates an example history_sp_printable page. This page uses the same data from the history_sp page and presents the data in a different format (e.g., Excel, Word). A dialog box pops up with the legend “Please click on File and then Print”.

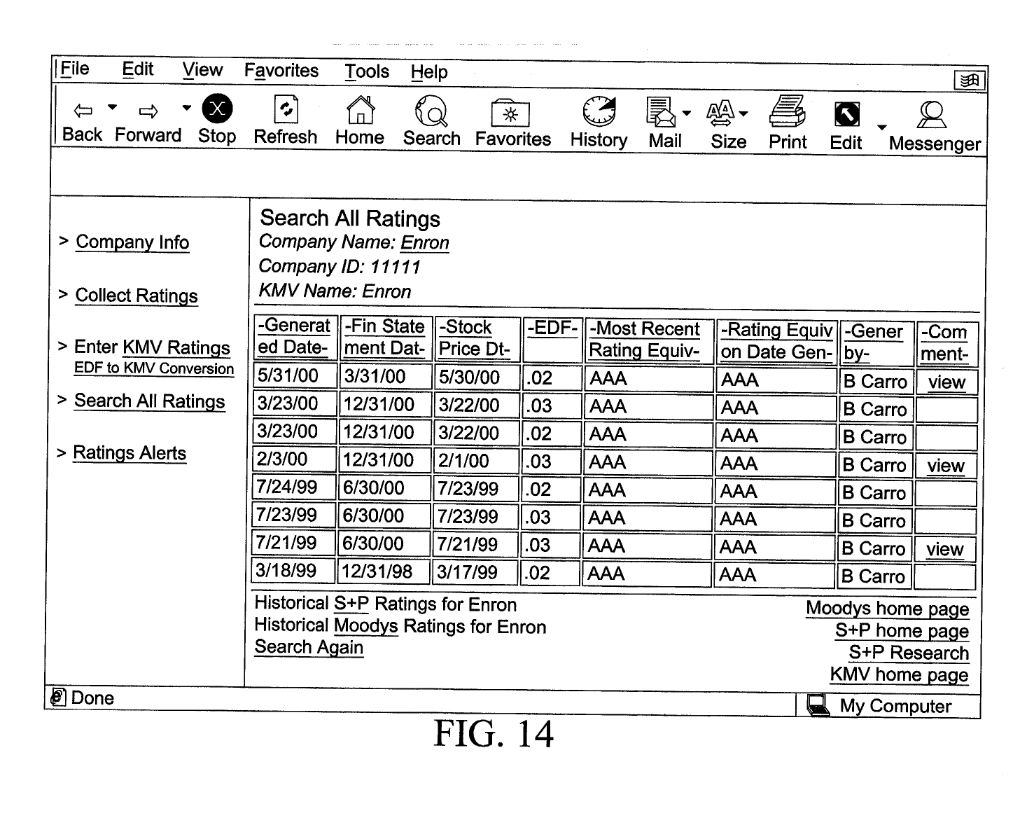

FIG. 14 illustrates an example history_kmv page that shows the historical rating that a particular company has within KMV. These ratings are only available for companies that have a kmv_pid in the master table. The page also includes links at the bottom of the page to facilitate navigation. Logic for this page is below.

```
Page Creation Logic:
    Make each column searchable. Include an up or down arrow in each
    table
header to indicate current sort order
IF companyid IS NOT blank THEN
select company.company_name,
  sfg_kmv_ratings.company_id,
  sfg_kmv_ratings.kmv_pid,
  sfg_kmv_ratings.edf_rating ,
  sfg_kmv_ratings.generated_date ,
  sfg_kmv_ratings.generated_by ,
  sfg_kmv_ratings.financial_date,
  sfg_kmv_ratings.stock_price_date,
  sfg_kmv_ratings.kmv_rating ,
  kmv_edf_map.rating
from sfg_kmv_ratings,
    company,
    kmv_edf_map
where company.company_id = form.companyid
  and company.company_id = sfg_kmv_ratings.company_id
  and kmv_edf_map.effective_date =
  (select max(d.effective_date)
    from kmv_edf_map d )
  and sfg_kmv_ratings.edf_rating
  between kmv_edf_map.edf_lower and kmv_edf_map.edf_upper
  and sfg_kmv_ratings.edf_rating <> 0
union
select company.company_name,
  sfg_kmv_ratings.company_id,
  sfg_kmv_ratings.kmv_pid,
  sfg_kmv_ratings.edf_rating,
  sfg_kmv_ratings.generated_date,
  sfg_kmv_ratings.generated_by,
  sfg_kmv_ratings.financial_date,
  sfg_kmv_ratings.stock_price_date,
    sfg_kmv_ratings.kmv_rating,
  sfg_kmv_ratings.kmv_rating
  from sfg_kmv_ratings,
      company
where company.company_id = form.companyid
  and company.company_id = sfg_kmv_ratings.company_id
      and sfg_kmv_ratings.edf_rating = 0 order by 5 desc ;
IF companyid IS blank THEN
    SELECT kmv.company_name,
        ‘ ‘,
          Kmv.kmv_pid,
          kmv_ratings.edf_rating,
          Kmv_ratings.generated_date,
          ‘KMV’,
        kmv_ratings.financial_date,
        kmv_ratings.stock_price_date,
          kmv_edf_map.rating,
FROM kmv, kmv_ratings,
          kmv_edf_map
        WHERE kmv.kmv_pid = form.kmv_pid (passed from
previous screen)
    AND kmv.kmv_pid = kmv_pid
        AND kmv_ratings.generated_date =
            (select Max(c.generated_date)
            from kmv_ratings c
            where c.kmv_pid = kmv_ratings.kmv_pid)
          and kmv_edf_map.effective_date =
            (select max(d.effective_date) from kmv_edf_map d )
              and kmv_ratings.edf_rating
            between kmv_edf_map.edf_lower and
kmv_edf_map.edf_upper
              order by Kmv_ratings.generated_date desc ;
history_moody link:
    IF EXIST moodys_issuer_nbr THEN create link history_moody
    passing
moodys_issuer_nbr and companyid
history_sp link:
    IF EXIST standard_poors_nbr THEN create link history_sp passing
standard_poors_nbr and companyid
“Search Again” Button:
  Link to ratings_search
Moodys home page link:
  Links to http://www.moodys.com
S+P research link:
  http://www.standardandpoors.com/ratingsdirect
Links to
S+P home page link:
  Links to http://www.standardandpoors.com
KMV homepage link:
  Links to http://www.kmv.com
```

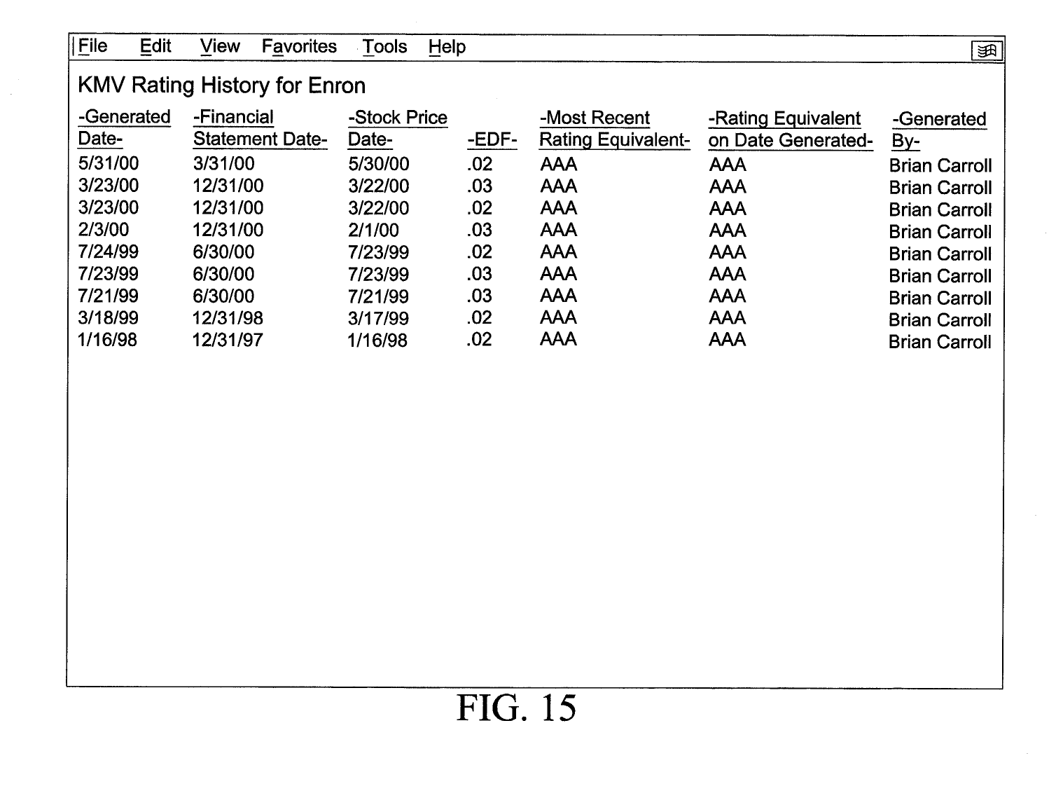

FIG. 15 illustrates an example history_kmv_printable page. This page uses the same data from the history_kmv page and presents the data in a different format (e.g., Excel, Word). A dialog box pops up with the legend “Please click on File and the Print”.

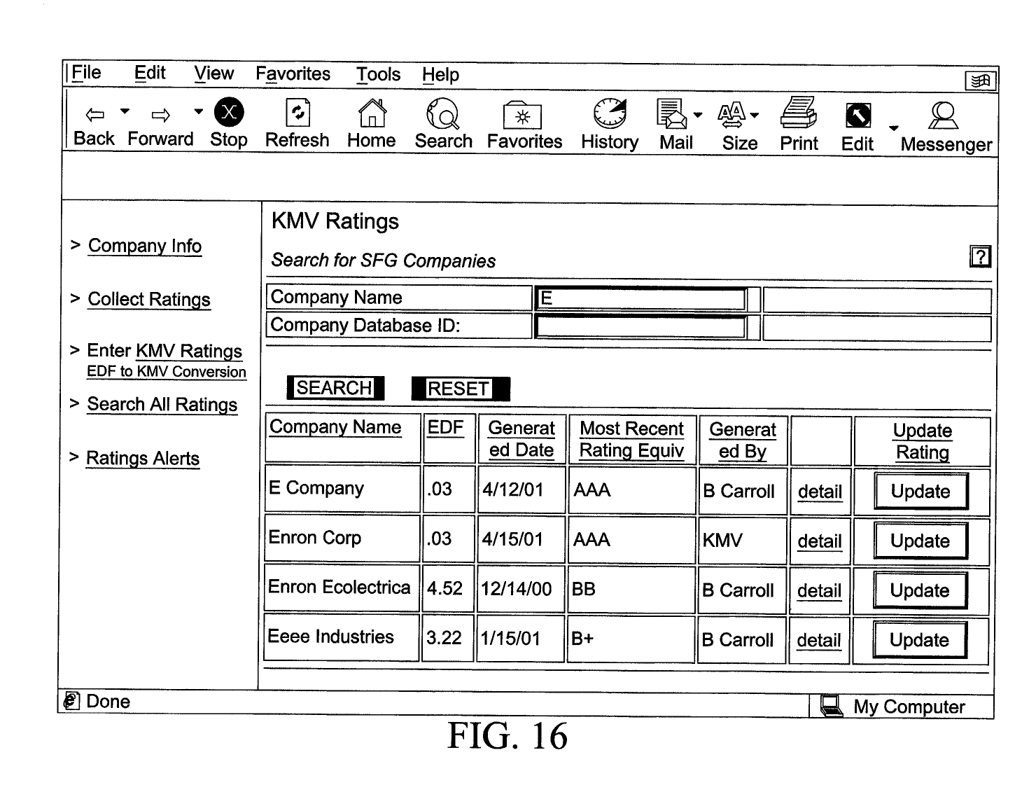

The login page links to a Kmv_spread_search page, as shown in FIG. 16. A user can enter a company name and/or company database identifier (ID) via this page, and the system then searches the company.sfg_kmv_ratings table based on companyid, and companyname and returns the results. A user can drill down and view more ratings detail, or go to a page to update ratings information. The Kmv_spread_search logic is set forth below.

```
IF CompanyID is given then
  select
  company.company_name,
sfg_kmv_ratings.company_id,
sfg_kmv_ratings.kmv_pid,
sfg_kmv_ratings.edf_rating,
sfg_kmv_ratings.generated_date,
sfg_kmv_ratings.generated_by,
kmv_edf_map.rating
from sfg_kmv_ratings,
  company,
  kmv_edf_map
where
  company.company_id = form.companyid
and company.company_id = sfg_kmv_ratings.company_id
and sfg_kmv_ratings.generated_date =
(select Max(c.generated_date)
  from sfg_kmv_ratings c
  where c.company_id = sfg_kmv_ratings.company_id)
and kmv_edf_map.effective_date =
(select max(d.effective_date)
  from kmv_edf_map d )
and sfg_kmv_ratings.edf_rating
between kmv_edf_map.edf_lower and kmv_edf_map.edf_upper
and sfg_kmv_ratings.edf_rating <> 0
union
select
company.company_name,
sfg_kmv_ratings.company_id,
sfg_kmv_ratings.kmv_pid,
sfg_kmv_ratings.edf_rating,
sfg_kmv_ratings.generated_date,
sfg_kmv_ratings.generated_by,
sfg_kmv_ratings.kmv_rating
from sfg_kmv_ratings,
  company
where
company.company_id = form.companyid
and company.company_id = sfg_kmv_ratings.company_id
and sfg_kmv_ratings.generated_date =
(select Max(c.generated_date)
  from sfg_kmv_ratings c
  where c.company_id = sfg_kmv_ratings.company_id)
and sfg_kmv_ratings.edf_rating = 0 ;
```

If Companyname is given then the following logic is used.

```
  select
company.company_name,
sfg_kmv_ratings.company_id,
sfg_kmv_ratings.kmv_pid,
sfg_kmv_ratings.edf_rating,
sfg_kmv_ratings.generated_date,
sfg_kmv_ratings.generated_by,
kmv_edf_map.rating
from sfg_kmv_ratings,
  company,
  kmv_edf_map
where
company.company_name like UPPER(‘form.companyname%’)
and company.company_id = sfg_kmv_ratings.company_id
and sfg_kmv_ratings.generated_date =
(select Max(c.generated_date)
  from sfg_kmv_ratings c
  where c.company_id = sfg_kmv_ratings.company_id)
and kmv_edf_map.effective_date =
(select max(d.effective_date)
  from kmv_edf_map d )
and sfg_kmv_ratings.edf_rating
between kmv_edf_map.edf_lower and kmv_edf_map.edf_upper
and sfg_kmv_ratings.edf_rating <> 0
union
select
company.company_name,
sfg_kmv_ratings.company_id,
sfg_kmv_ratings.kmv_pid,
sfg_kmv_ratings.edf_rating ,
sfg_kmv_ratings.generated_date ,
sfg_kmv_ratings.generated_by ,
sfg_kmv_ratings.kmv_rating
from sfg_kmv_ratings,
  company
  where company.company_name like UPPER(‘form.companyname%’)
and company.company_id = sfg_kmv_ratings.company_id
and sfg_kmv_ratings.generated_date =
(select Max(c.generated_date)
  from sfg_kmv_ratings c
  where c.company_id = sfg_kmv_ratings.company_id)
  and sfg_kmv_ratings.edf_rating = 0 ;
```

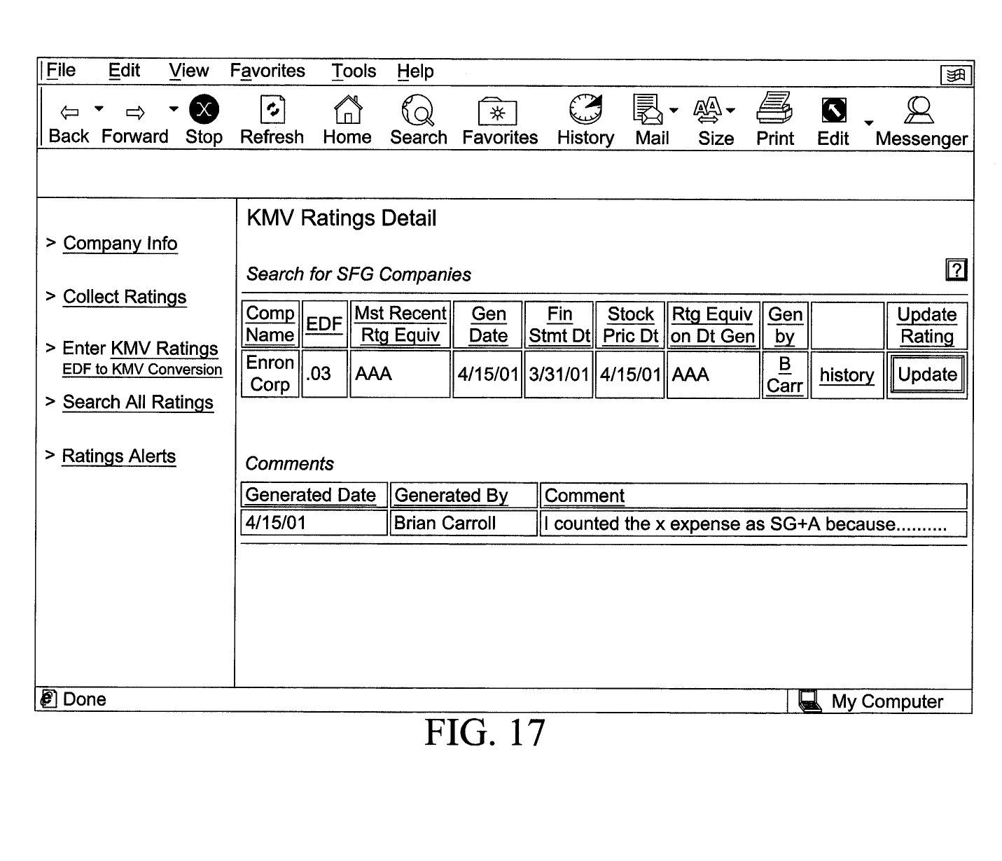

FIG. 17 illustrates an example KMV_ratings_detail page that provides more detailed ratings information and also enables the user to obtain historical ratings and to go to the page where ratings are changed. The logic for this page is below.

```
SELECT company.company_name as COMPANY_NAME,
      sfg_kmv_ratings.company_id as COMPANY_ID,
      nvl(sfg_kmv_ratings.kmv_pid, ‘’)as KMV_PID,
      nvl(sfg_kmv_ratings.edf_rating, ‘’)as EDF_RATING,
      to_char(nvl(sfg_kmv_ratings.generated_date,sysdate),
‘mm/dd/yyyy’)as GENERATED_DATE,
      nvl(sfg_kmv_ratings.generated_by, ‘ ’)as GENERATED_BY,
      to_char(nvl(sfg_kmv_ratings.financial_date,sysdate),
‘mm/dd/yyyy’)as FINANCIAL_DATE,
      to_char(nvl(sfg_kmv_ratings.stock_price_date,sysdate),
‘mm/dd/yyyy’)as STOCK_PRICE_DATE,
      nvl(sfg_kmv_ratings.kmv_rating, ‘ ’)as KMV_RATING,
      nvl(kmv_edf_map.rating, ‘ ’)as RATING
      FROM sfg_kmv_ratings,
      company,
      kmv_edf_map
      WHERE company.company_id = form.companyid
      AND company.company_id = sfg_kmv_ratings.company_id
      AND sfg_kmv_ratings.generated_date =
      (select Max(c.generated_date) from sfg_kmv_ratings c where
c.company_id =sfg_kmv_ratings.company_id)
      AND kmv_edf_map.effective_date =
      (select max(d.effective_date) from kmv_edf_map d )
      AND sfg_kmv_ratings.edf_rating
      between kmv_edf_map.edf_lower and
kmv_edf_map.edf_upper
      AND sfg_kmv_ratings.edf_rating <> 0
      union
      SELECT
      company.company_name as COMPANY_NAME,
      sfg_kmv_ratings.company_id as COMPANY_ID,
      nvl(sfg_kmv_ratings.kmv_pid, ‘’)as KMV_PID,
      nvl(sfg_kmv_ratings.edf_rating, ‘’)as EDF_RATING,
      to_char(nvl(sfg_kmv_ratings.generated_date,sysdate),
‘mm/dd/yyyy’)as GENERATED_DATE,
      nvl(sfg_kmv_ratings.generated_by, ‘ ’)as GENERATED_BY,
      to_char(nvl(sfg_kmv_ratings.financial_date,sysdate),
‘mm/dd/yyyy’)as FINANCIAL_DATE,
      to_char(nvl(sfg_kmv_ratings.stock_price_date,sysdate),
‘mm/dd/yyyy’)as STOCK_PRICE_DATE,
      nvl(sfg_kmv_ratings.kmv_rating, ‘ ’)as KMV_RATING,
      nvl(sfg_kmv_ratings.kmv_rating, ‘ ’)as RATING
      FROM sfg_kmv_ratings,
      company
      WHERE company.company_id = form.companyid
      AND company.company_id = sfg_kmv_ratings.company_id
      AND sfg_kmv_ratings.generated_date =
      (select Max(c.generated_date) from sfg_kmv_ratings c where
c.company_id =sfg_kmv_ratings.company_id)
      AND sfg_kmv_ratings.edf_rating = 0
Comments:
  SELECT generated_date,
    generated_by
    kmv_comment
  FROM kmv.ratings.comment
  WHERE company_id = form.company_id
          and generated_date =
      (SELECT max(c.generated_date)
      FROM kmv_ratings_comment c
      WHERE c.company_id = kmv_ratings_comment.company_id)
```

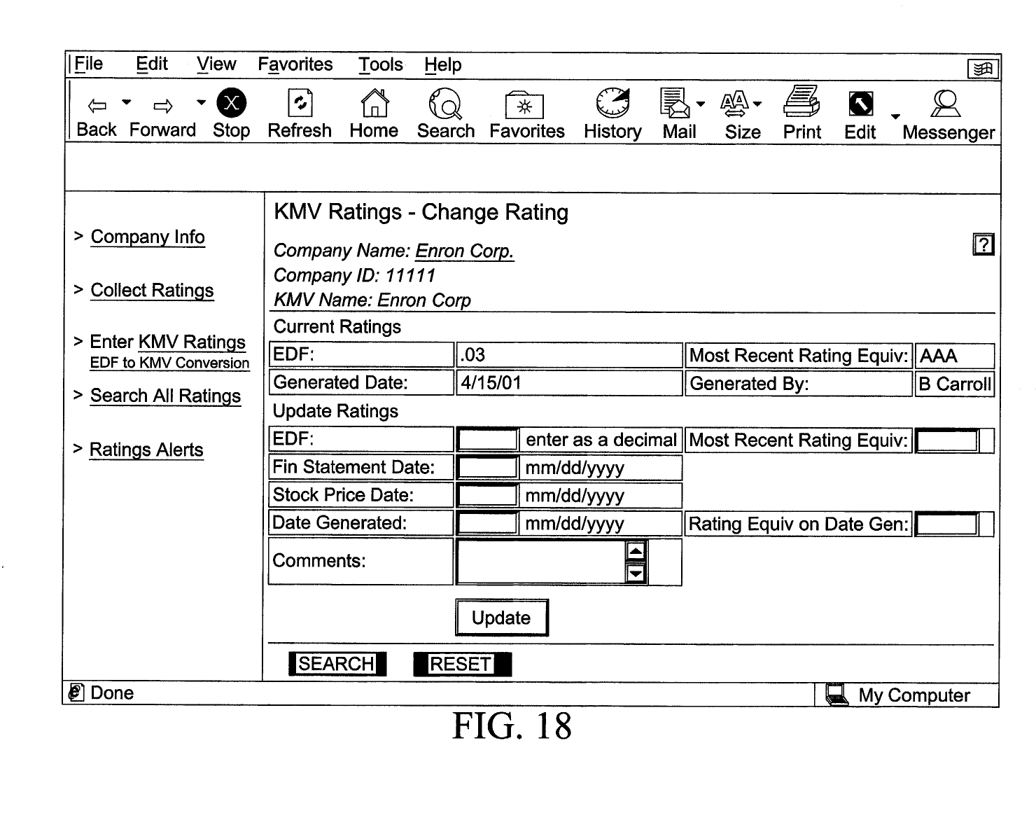

FIG. 18 illustrates an example Kmv_ratings_change page that enables a user to view the current ratings information for a company, and then enter in a new rating. Once the rating is submitted by selecting “Update” button, the user is given a confirmation message. The logic for this page is below.

| | |
|---|---|
| SELECT | company.company_name, |

sfg_kmv_ratings.company_id,
sfg_kmv_ratings.kmv_pid,
to_char(sfg_kmv_ratings.generated_date,′mm/dd/yyyy′),
sfg_kmv_ratings.generated_by, sfg_kmv_ratings.edf_rating,
kmv_edf_map.rating

| | |
|---|---|
| FROM | sfg_kmv_ratings, |
| company, | |
| kmv_edf_map | |
| WHERE | company.company_id = form.Company ID |
| AND | company.company_id = sfg_kmv_ratings.company_id |
| AND | sfg_kmv_ratings.generated_date = |

(SELECT Max(c.generated_date)
FROM sfg_kmv_ratings c
WHERE c.company_id = sfg_kmv_ratings.company_id)
AND kmv_edf_map.effective_date =
(SELECT max(d.effective_date)
FROM kmv_edf_map d) AND sfg_kmv_ratings.edf_rating BETWEEN
kmv_edf_map.edf_lower and kmv_edf_map.edf_upper
AND sfg_kmv_ratings.edf_rating <>0
UNION

| | |
|---|---|
| SELECT | company.company_name, |

sfg_kmv_ratings.company_id,
sfg_kmv_ratings.kmv_pid, to_char(sfg_kmv_ratings.generated_date, ′mm/dd/yyyy′),
sfg_kmv_ratings.generated_by,
sfg_kmv_ratings.edf_rating,
sfg_kmv_ratings.kmv_rating

| | |
|---|---|
| FROM | sfg_kmv_ratings,company |
| WHERE | company.company_id = form.Company ID |
| AND | company.company_id = sfg_kmv_ratings.company_id |
| AND | sfg_kmv_ratings.generated_date = |

(SELECT Max(c.generated_date)
FROM sfg_kmv_ratings c
WHERE c.company_id = sfg_kmv_ratings.company_id)
AND sfg_kmv_ratings.edf_rating = 0

Once the new edf and generated date are entered, i.e., before the update button is selected, the system generates a ratings equivalent on the generated date as follows.

Select Rating
From kmv_edf_map
Where effective_date = (select max(a.effective_date) from

kmv_edf_map a

where a.effective_date <= form.generated_date)
and form.newEDF
between kmv_edf_map.edf_lower and kmv_edf_map.edf_upper;

The validation logic is set forth below.

New EDF <= 20 AND >= 0

IF New EDF = 0, then the rating equivalent will be entered by the user
If the user enters a edf = 0,

then the most recent rating
equivalent and rating equivalent on date generated will be the
same. The user can then enter ‘IC’,‘ID’.’N/A’,’Funds’ for the ratings

If the user enters an edf > 0, then the system should

generate the most recent rating equivalent and
rating equivalent on date generated

IF generated by = ‘KMV’ AND comment is null THEN issue

warning “Comment must be entered when adding a rating for a company that
KMV spreads.”

Financial Statement Date = mm/dd/yyyy else warning
Stock price date = mm/dd/yyyy or NULL
Date Generated = mm/dd/yyyy else warning
Date Generated >= financial_statement_date
Date Generated >= stock_price_date
Stock_price_date IF NULL
SELECT count(*)
FROM sfg_kmv_ratings
WHERE company_id = form.company_id
AND stock_price_date is NOT NULL
IF count(*) > 0 THEN generate warning

Once the new edf is entered, and before the update button is selected, the system generates the most recent ratings equivalent as follows.

SELECT Rating,

| FROM kmv_edf_map | |
|---|---|
| WHERE | effective_date = |
| | (select max(a.effective_date) |
| | from kmv_edf_map a) |
| | and form.newEDF |
| | between kmv_edf_map.edf_lower and |

kmv_edf_map.edf_upper;
Update Button Logic:

| INSERT into sfg_kmv_ratings | |
|---|---|
| (company_id | = form.companyid |
| kmv_pid | = form.kmv_pid |
| generated_date | = form.generated_date |
| generated_by | = addresses.lastname∥’, |
| | ‘∥ addresses.firstname of current user |
| financial_date | = form.financial_date |
| stock_price_date | = form.stock_price_date |
| edf_rating | = form.newedf |
| kmv_rating | = form.rating_equivalent) |
| INSERT into kmv_ratings_comment | |
| (company_id | = form.companyid |
| kmv_pid | = form.kmv_pid |
| generated_date | = form.generated_date |
| generated_by | = addresses.lastname∥’, |
| | ‘∥ addresses.firstname of current user |
| financial_date | = form.financial_date |
| stock_price_date | = form.stock_price_date |
| kmv_comment | = form.comments |

ISSUE a confirmation message that says,
“Rating for Company X updated!”

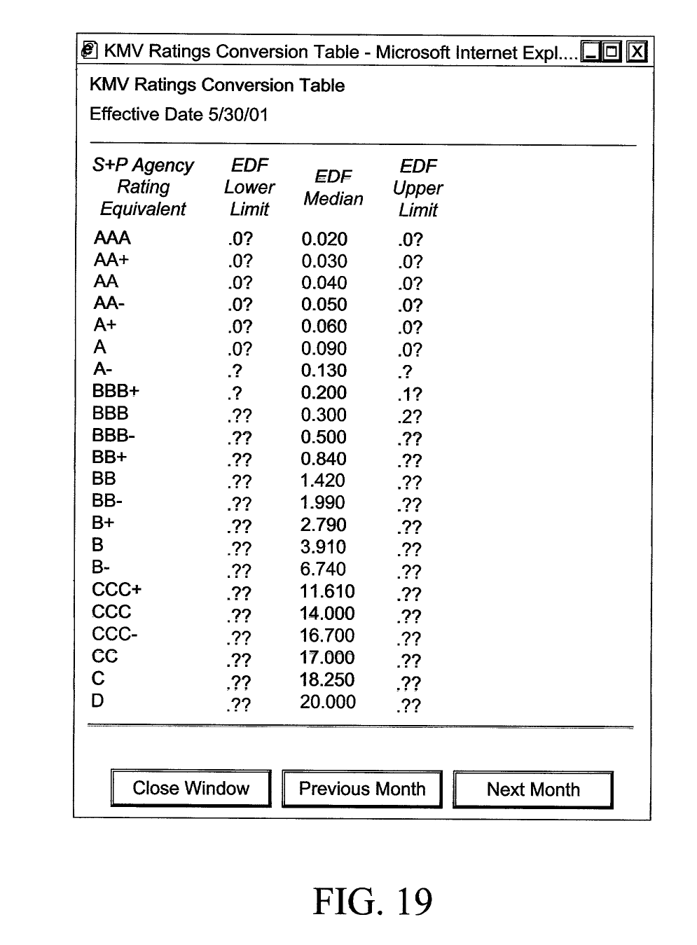

FIG. 19 illustrates an example Kmv_conversion_table page. This page opens in a separate window and displays the conversion tabled for edf ratings based on the database. Logic for this page is below.

Conversion Table:

| | |
|---|---|
| SELECT | effective_date, |

kmv_edf_map.Rating,
edf_lower,
edf_median,
edf_upper,
Group_num (hide field on screen)

| FROM kmv_edf_map, kmv_edf_map_order | |
|---|---|
| WHERE | kmv_edf_map.Rating = |
| | kmv_edf_map_order.rating |

AND effective_date =

| (SELECT max(a.effective_date) | |
|---|---|
| FROM kmv_edf_map a | |
| WHERE | a.effective_date <= form.effective_date) |
| ORDER BY | sortnum |

Prior Button:

| | |
|---|---|
| SELECT | effective_date, |

kmv_edf_map.rating,
edf_lower,
edf_median,
edf_uppper,
Group_num (hide)

| FROM kmv_edf_map, kmv_edf_map_order | |
|---|---|
| WHERE | kmv_edf_map.Rating = |
| | kmv_edf_map_order.rating |
| AND group_num = form.group_num−1 | |
| ORDER BY | sortnum |

Next Button:

| | |
|---|---|
| SELECT | effective_date, |

kmv_edf_map.rating,
edf_lower,
edf_median,
edf_uppper,
Group_num (hide)

| | |
|---|---|
| FROM kmv_edf_map, | kmv_edf_map order |

| | |
|---|---|
| WHERE | kmv_edf_map.Rating = |

| kmv_edf_map_order.rating | |
|---|---|
| AND group_num = | form.group_num+1 |

| | |
|---|---|
| ORDER BY | sortnum |

In addition to the company information application and search all ratings application described above, the system includes other applications such as the collect ratings application, the ratings alerts application, and the KMV ratings application. The collect ratings application is utilized to obtain ratings information from designated data sources such as ratings services and from databases within the system. The alert application is utilized to designate certain events and notifications to be sent upon the occurrence of an event. Users of the application can be alerted through e-mail if the ratings or status of a company changes. The users select the companies and type of change they are interested in tracking. When the company has such a change, an e-mail will be sent to the user. For example, if the rating or outlook of a particular company changes, a notification can be sent (e.g., via e-mail) to the individuals within the company handling transactions in connection with that particular company. The KMV ratings application is utilized to obtain ratings information from KMV and to facilitate use of the KMV information across the company. More specifically, via a user computer, a user inputs (e.g., to the system processor) instructions identifying a company and a type of change relating to the company which the user desires to receive notification. As data is supplied to the system, the data is stored in the database. The system/server processor periodically (e.g., daily) selects at least one database to search based on the specified type of change and the company. The processor also selects at least one of the company names linked to the unique identifier to utilize in the search. The processor then performs the search in the selected databases using the selected company names, and compares the data identified in the search with the user specified notification information to determine whether the specified type of change has occurred. If the change has occurred, then the processor transmits a notification to the user computer.

The single access to ratings information by the system described above enhances consistency and facilitates preventing errors in use of that information. In addition, such system and method facilitate improving productivity by enabling one-time entry of company information. Also, the linked information is automatically fed into the several reporting systems that use the information, including automated alert notifications as described above. Such linking also facilitates monitoring portfolios of companies.

While the invention has been described in terms of various specific embodiments, those skilled in the art will recognize that the invention can be practiced with modification within the spirit and scope of the claims.

What is claimed is:

1. A method for operating a computer in response to a search request for company data for one company stored in a plurality of databases, a plurality of company names being linked to a unique identifier for the one company, the search request identifying a data type and the one company, said method comprising the steps of operating the computer to:
select at least one of said databases to search based on the identified data type and company;
select at least one of said plurality of company names to utilize in the search; and
perform the search in the selected databases using the selected company names.

2. A method according to claim 1 wherein selecting at least one of said databases comprises the steps of determining which of said databases has the identified data type for the one company stored therein, and selecting at least one of said determined databases.

3. A method according to claim 1 wherein selecting at least one of said plurality of company names comprises the step of determining which ones of said company names are utilized in the selected databases.

4. A company database system comprising a plurality of databases, at least one processor coupled to said databases, and a memory coupled to said processor, said memory having a plurality of unique company identifiers stored therein, each of said unique company identifiers linked to at least one company name.

5. A company database system according to claim 4 further comprising data logic stored in said memory, said data logic identifying at least one database in which a type of data for at least one company is stored.

6. A company database system according to claim 4 wherein said processor is programmed to:
select at least one of said databases to search based on an identified data type and company;
select at least one of said plurality of company names to utilize in the search; and
perform the search in the selected databases using the selected company names.

7. A database system comprising a plurality of databases, at least one of said databases having a plurality of unique company identifiers stored therein, each said identifier linked to at least one company name.

8. A database system according to claim 7 further having data logic stored therein, said data logic identifying at least one database in which a type of data for at least one company is stored.

9. A database system according to claim 7 further comprising a processor programmed to:
select at least one database to search based on an identified data type and company;
select at least one company name to utilize in the search; and
perform the search in the selected databases using the selected company name.

10. A database system according to claim 7 wherein a plurality of company names for the one company name are linked to said unique company identifier.

11. A method for alerting a user of a change in status of a company, company data being stored in at least one database coupled to a processor, a unique identifier being associated with at least one name of the company, the processor coupled to a communications network, a user computer coupled to the communications network, said method comprising the steps of:
receiving, at the processor, user instructions regarding a company and a type of change relating to the company which a user desires to receive notification on;
storing, in the database, company data;
operating the processor to select at least one database to search based on the specified type of change and the company;
operating the processor to select at least one of the company names linked to the unique identifier to utilize in the search;
operating the processor to perform the search in the selected databases using the selected company names;
operating the processor to compare data identified in the search with the user specified notification information to determine whether the specified type of change has occurred; and
operating the processor to transmit a notification to the user computer if the specified type of change has occurred.

12. A method according to claim 11 wherein selecting at least one of the databases comprises the steps of determining which of the databases has the identified data type for the one company stored therein, and selecting at least one of the determined databases.

13. A method according to claim 11 wherein selecting at least one of the plurality of company names comprises the step of determining which ones of the company names are utilized in the selected databases.
